(19) United States
(12) Patent Application Publication
(10) Pub. No.: US 2011/0288979 A1
(43) Pub. Date: Nov. 24, 2011

(54) Premium Computation Device for Currency Option, Program, and Storage Medium

(76) Inventors: Ikuya Matsukawa, Tokyo (JP); Manabu Yakushijin, Tokyo (JP)

(21) Appl. No.: 12/935,226

(22) PCT Filed: Mar. 28, 2008
(86) PCT No.: PCT/JP2008/056099

§ 371 Date: Dec. 14, 2010

(51) Int. Cl. G06Q 40/00

(52) U.S. Cl. 705/37

(57) ABSTRACT

As options used to compute a premium of a currency option to be evaluated, forward delta call/put plain options based on a forward rate are applied in addition to an ATM plain option, volatilities of the forward delta call/put plain options are computed, and an exercise price of the forward delta call plain option is computed using the volatility and an exercise price of the forward delta put plain option is computed using the volatility, thereby using the computed results for a computation of a premium for computing a correction value.

### TECHNICAL FIELD

The present invention relates to a premium computation device for a currency option, a program, and a storage medium, and in particular to a premium computation device for a currency option for computing a premium of a currency option to be evaluated, a premium computation program for a currency option for causing a computer to function as the premium computation device for the currency option, and a storage medium to which the premium computation program of the currency option is recorded.

### BACKGROUND ART

A currency option is a right capable of buying (a case of a call option) or selling (a case of an put option) a currency on a predetermined exercise date or within a predetermined exercise term at a predetermined exercise price (strike price). Even if a spot rate of a dollar-yen exchange rate exceeds 100 yen per 1 dollar because dollar rises, an owner of a dollar call option whose exercise price is, for example, 100 yen per 1 dollar can buy dollar at an exchange rate of 100 yen per 1 dollar by exercising a right of option. Accordingly, the owner can obtain an exchange profit by selling dollar at a spot rate higher than 100 yen per 1 dollar (for example, 105 yen per 1 dollar) and buying dollar at a spot rate of 100 yen per 1 dollar by exercising the right of option. Further, if the spot rate of the dollar-yen exchange rate falls below 100 yen per 1 dollar because dollar falls, the owner can buy dollar at the spot rate without exercising the right of option.

Likewise, even if the spot rate of the dollar-yen exchange rate falls below 100 yen per 1 dollar because dollar falls, an owner of a dollar put option whose exercise price is 100 yen per 1 dollar can obtain an exchange profit by selling dollar at the exchange rate of 100 yen per 1 dollar by exercising a right of option, and if the spot rate of the dollar-yen exchange rate exceeds 100 yen per 1 dollar, the owner can sell dollar at the spot rate without exercising a right of option. As described above, the currency option has a function for hedging against a risk of loss due to a fluctuation of an exchange rate while securing a chance of obtaining an exchange profit, and a buyer of the currency option must pay a premium to a seller as compensation for the hedge.

To permit a transaction of a currency option to be appropriately performed in a market, a premium (price) of a currency option must be computed and determined so as to set the premium to a value which reflects a magnitude of risk of a risk guarantor (a seller) of the currency option. At present, Garman=Korhalgen model which modifies Black=Scholes model to use Black=Scholes model for currency option or a framework which further modifies Black-Scholes model using Black-Scholes model (hereinafter called a frame work of GK model) as its base are ordinarily used as a method of computing a premium of a currency option. In the framework of GK model, a premium of a currency option is formularized using volatilities (expected fluctuation rates) and the like of an exercise price and an exchange rate as variables. Since the exercise price and the like are given parameters and volatilities of an exchange rate are also presented to a market, the premium of the currency option can be simply computed using the framework of GK model.

However, Black=Scholes model and GK model based on Black=Scholes model premise that a price of an underlying asset such as an exchange rate and the like varies according to a probability distribution prescribed by a normal distribution, whereas a probability distribution of a variation of an actual exchange rate and the like is different from the normal distribution. Therefore, even if a premium of a currency option is determined using Black=Scholes model and GK model, a problem rises in that a value of an obtained premium is deviated from an actual probability distribution (risk) and a correction premium cannot be obtained.

To solve the problem, the applicant of the invention proposes a technique in Patent Document 1 (Japanese Patent Application Laid-Open (JP-A) No. 2002-230304) in which a vega, a volga, and a vanna are computed with respect to an option to be evaluated and to three types plain options, that is, an ATM (At The Money) plain option, a 25 delta call plain option, and a 25 delta put plain option whose term is the same as the option to be evaluated, a portfolio component rate is computed so that a vega, a volga, and a vanna of a portfolio obtained by combining the three types of the plain options match with a vega, a volga, and a vanna of the option to be evaluated. Then, with respect to the 25 delta call plain option and the 25 delta put plain option, a difference between a premium computed from an ATM flat volatility σ_{ATM} and a premium computed from market values σ_{C25}, σ_{P25} of volatilities of the 25 delta call plain option and the 25 delta put plain option is computed, and a premium of the option to be evaluated, which is computed from σ_{ATM}, is corrected by a sum of the differences weighted by the component rate.

Further, in relation to the above, Patent Document 2 (Japanese Patent Application Laid-Open (JP-A) No. 2002-288436) discloses a technique for creating a time-sequential volatility curve representing a change of a volatility to a term and creating a smile curve representing a volatility to a delta value, creating a volatility curved surface model acting as a reference from the time-sequential volatility curve and the smile curve, setting a reasonable price range in the volatility curved surface model, and receiving a volatility input for examination and determining whether or not the volatility is within the reasonable price zone by the reference volatility curved surface model to which the reasonable price zone is set.

### DISCLOSURE OF THE INVENTION

### Problems to be Solved by the Invention

In the technique described in Patent Document 1, exercise prices of the respective options are computed in order to compute the vega, the volga, and the vanna of the respective options, and a volatility (volatility at present) at a spot rate is used to compute exercise prices and the like of the 25 delta call plain option and the 25 delta put plain option. However, in currency options traded in a market, a currency option of a short term less than one year is traded based on the spot rate and a volatility based on the spot rate is used as a market value of the volatility. Whereas, a currency option of a long term longer than one year is traded based on a forward rate (which can be uniquely computed from the spot rate based of an investment profit (=interest rate×interest term) during a term) which is an exchange rate at the time of an exercise date of the currency option, and a volatility based on the forward rate is used as a market value of the volatility.

Therefore, in the technique described in Patent Document 1, when a currency option to be evaluated has a long term longer than one year and a corresponding volatility is a volatility having a market value based on the forward rate, after a market value of an obtained volatility is converted to a volatility of the spot rate base based on an interest rate and an interest term, the volatility is used to compute an exercise price and the like. However, if a term of a currency option to be evaluated is relatively long and an interest rate is also relatively high, a value of a discount factor (=interest rate and interest term: discount rate), which is used for conversion between a spot rate and a forward rate, may become 0.5 (50%). In the case, a problem arises in that a premium is placed in an incomputable state because the exercise prices of the ATM plain option, the 25 delta call plain option, and the 25 delta put plain option become equal to each other (values of the 25 deltas become equal to a value of a 50 delta (=ATM) by 25÷0.5=50).

An object of the invention, which was made in view of the above facts, is to obtain a premium computation device of a currency option, a premium computation program of a currency option, and a storage medium which can avoid that a premium of a currency option to be evaluated is placed in an incomputable state.

### Means for Solving the Problem

To achieve the above object, a premium computation device for a currency option of an invention according to a first aspect, there is provided a premium computation device for a currency option including: a first acquisition unit which obtains a first parameter capable of specifying an exercise date and an exercise term of a currency option to be evaluated and a second parameter representing an exercise price or a delta of the currency option to be evaluated and which stores the obtained first parameter and second parameter in a first storage unit; a second acquisition unit which obtains an ATM flat volatility representing a market value of a volatility of an ATM plain option whose exercise term is the same as the exercise term of the currency option to be evaluated which is capable of being specified from the first parameter and volatility information representing a market value of a volatility of a forward delta call plain option and a volatility of a forward delta put plain option in which a delta has a predetermined value based on a forward rate that is an exchange rate uniquely determined from a spot rate, an interest rate and a term at an exercise date of the currency option to be evaluated whose exercise term is the same as the currency option to be evaluated and which is capable of being specified from the first parameter and which stores the obtained ATM flat volatility and volatility information in a second storage unit; a first premium computation unit which reads the second parameter from the first storage unit and reads the ATM flat volatility from the second storage unit, which computes a premium of the currency option to be evaluated using the ATM flat volatility read from the second storage unit and an exercise price of the currency option to be evaluated by computation processing of a computer, after the exercise price of the currency option to be evaluated is computed based on a delta of the currency option to be evaluated represented by the second parameter by computation processing of the computer if the second parameter read from the first storage unit represents a delta of the currency option to be evaluated, and which stores the computed premium of the currency option to be evaluated in a third storage unit; a risk parameter computation unit which reads the ATM flat volatility from the second storage unit and reads the premium of the currency option to be evaluated from the third storage unit, which computes a predetermined risk parameter with respect to the currency option to be evaluated using the ATM flat volatility read from the second storage unit and the premium of the currency option to be evaluated read from the third storage unit by computation processing of the computer, and which stores the computed predetermined risk parameter in a fourth storage unit; an exercise price computation unit which reads the ATM flat volatility and the volatility information from the second storage unit, which computes an exercise price of the ATM plain option using the ATM flat volatility read from the second storage unit and computes an exercise price of the forward delta call plain option using a volatility of the forward delta call plain option represented by the volatility information read from the second storage unit by computation processing of the computer, which further computes an exercise price of the forward delta put plain option using a volatility of the forward delta put plain option represented by the volatility information read from the second storage unit by computation processing of the computer, and which stores the computed exercise prices of the respective plain options in a fifth storage unit; a second premium computation unit which reads the ATM flat volatility and the volatility information from the second storage unit and reads the exercise prices of the respective plain options from the fifth storage unit, which computes a premium of the ATM plain option using the ATM flat volatility read from the second storage unit and the exercise price of the ATM plain option read from the fifth storage unit and computes a premium of the forward delta call plain option using the volatility of the forward delta call plain option represented by the volatility information read from the second storage unit and the exercise price of the forward delta call plain option read from the fifth storage unit by computation processing of the computer, which further computes a premium of the forward delta put plain option using the volatility of the forward delta put plain option represented by the volatility information read from the second storage unit and the exercise price of the forward delta put plain option read from the fifth storage unit by computation processing of the computer, and which stores the computed premiums of the respective plain options in a sixth storage unit; a component rate computation unit which reads the predetermined risk parameter of the currency option to be evaluated from the fourth storage unit and reads the ATM flat volatility and the volatility information from the second storage unit and reads the premiums of the respective plain options from the sixth storage unit, which computes a component rate of the respective plain options in a portfolio when a value of the predetermined risk parameter, with respect to the portfolio obtained by combining the respective plain options determined from the ATM flat volatility and the volatility information read from the second storage unit and the premiums of the respective plain options read from the sixth storage unit, is equal to the value of the predetermined risk parameter of the currency option to be evaluated read from the fourth storage unit by computation processing of the computer, and which stores the computed component rate in a seventh storage unit; a third premium computation unit which reads the ATM flat volatility from the second storage unit and reads the exercise prices of the respective plain options from the fifth storage unit, which computes a premium of the forward delta call plain option using the ATM flat volatility read from the second storage unit and the exercise price of the forward delta call plain option read from the fifth storage unit and computes a premium of the forward delta put plain option using the ATM flat volatility read from the second storage unit and the exercise price of the forward delta put plain option read from the fifth storage unit by computation processing of the computer, and which stores the computed premiums of the respective plain options in an eighth storage unit; a deviation computation unit which reads the premiums of the respective plain options from the sixth storage unit and the eighth storage unit, which computes deviations between the premiums read from the sixth storage unit and the premiums read from the eighth storage unit with respect to the respective plain options by computation processing of the computer, and which stores the computed deviations in a ninth storage unit; a correction value computation unit which reads the deviations of the respective plain options from the ninth storage unit and reads the component rate from the seventh storage unit, which computes a value obtained by adding the deviations of the respective plain options read from the ninth storage unit after the deviations are weighted according to the component rate read from the seventh storage unit as a correction value to the premium of the currency option to be evaluated by computation processing of the computer, and which stores the computed correction value in a tenth storage unit; a correction unit which reads the premium of the currency option to be evaluated from the third storage unit and reads the correction value from the tenth storage unit, which corrects the premium of the currency option to be evaluated read from the third storage unit by the correction value read from the tenth storage unit by computation processing of the computer, and which stores the premium after the correction in an eleventh storage unit; and an output unit which reads the premium after the correction from the eleventh storage unit and which outputs the premium after the correction as the premium of the currency option to be evaluated.

In the invention according to the first aspect, the first parameter capable of specifying the exercise date and the exercise term of the currency option to be evaluated and the second parameter representing the exercise price or the delta of the currency option to be evaluated are obtained by the first acquisition unit. Further, the ATM flat volatility representing the market value of the volatility of the ATM plain option whose exercise term is the same as the exercise term of the currency option to be evaluated and the volatility information representing the market values of the volatilities of the forward delta call plain option and the forward delta put plain option whose exercise terms are the same as the exercise term of the currency option to be evaluated and in which a delta based on a forward rate (an exchange rate on an exercise date of the currency option to be evaluated that is uniquely determined from a spot rate, an interest rate, and a term) has a predetermined value are obtained by the second acquisition unit.

Note that, as described in, for example, an eight aspect, the 25 forward delta call plain option in which the delta based in a forward rate is 0.25 is preferable as the forward delta call plain option, and, as described in, for example, the eighth aspect, the 25 forward delta put plain option in which the delta based on the forward rate is 0.25 is preferable also as the forward delta put plain option. However, the invention is by no means limited thereto, and other forward delta plain option in which the delta based on the forward rate has a value other than 0.25.

Further, if the second parameter represents the delta of the currency option to be evaluated by the first premium computation unit, after the exercise price of the currency option to be evaluated is computed based on the delta of the currency option to be evaluated represented by the second parameter, the premium of the currency option to be evaluated is computed using the ATM flat volatility and the exercise price of the currency option to be evaluated. Further, a predetermined risk parameter is computed with respect to the currency option to be evaluated by the risk parameter computation unit using the ATM flat volatility and the premium of the currency option to be evaluated. Note that as described in, for example, a sixth aspect, the parameter representing the risk to the change of volatility is preferable as the predetermined risk parameter, and, specifically, as described in, for example, a seventh aspect, the predetermined risk parameter may include at least one of the vega obtained by first-order differentiating the premium of the currency option by the volatility, the volga obtained by second-order differentiating the premium by the volatility, and the vanna obtained by first-order differentiating the vega by the spot rate. However, the invention is by no means limited thereto, and other parameter may be applied.

Further, the exercise price of the ATM plain option is computed by the exercise price computation unit using the ATM flat volatility and the exercise price of the forward delta call plain option is computed using the volatility of the forward delta call plain option represented by the volatility information and further an exercise price of the forward delta put plain option is computed using a volatility of the forward delta put plain option represented by the volatility information. Further, the premium of the ATM plain option is computed by the second premium computation unit using the ATM flat volatility and the exercise price of the ATM plain option and the premium of the forward delta call plain option is computed using the volatility of the forward delta call plain option represented by the volatility information and the exercise price of the forward delta call plain option and further the premium of the forward delta put plain option is computed using the volatility of the forward delta put plain option represented by the volatility information and the exercise price of the forward delta put plain option.

Further, the component rate of the respective plain options in the portfolio is computed by the component rate computation unit when the value of the predetermined risk parameter, which is determined from the ATM flat volatility and the volatility information, and the premiums of the respective plain options, by the component rate computation unit, with respect to the portfolio obtained by combining the respective plain options is equal to the value of the predetermined risk parameter of the currency option to be evaluated. Note that, more specifically, as described in a fifth aspect, the component rate computation unit may be configured such that after the component rate computation unit computes the predetermined risk parameters of the ATM plain option, the forward delta call plain option, and the forward delta put plain option, using an ATM flat volatility, volatility information, and the premiums of respective plain options, the component rate computation unit computes component rate of the respective plain options in the portfolio using the computed predetermined risk parameters of the respective computed plain options.

Further, the third premium computation unit computes the premium of the forward delta call plain option using the ATM flat volatility and the exercise price of the forward delta call plain option and computes the premium of the forward delta put plain option using the ATM flat volatility and the exercise price of the forward delta put plain option. The deviation computation unit computes the deviation between the premium computed by the second premium computation unit and the premium computed by the third premium computation unit with respect to the respective plain options. The correction value computation unit computes the value obtained by adding the deviations of the respective plain options computed by the correction value computation unit after the deviations are weighted according to the component rate computed by the component rate computation unit as the correction value to the premium of the currency option to be evaluated. Further, the premium of the currency option to be evaluated computed by the first premium computation unit is corrected by the correction value computed by the correction value computation unit, and the premium corrected by the correction unit is output by the output unit as the premium of the currency option to be evaluated.

As described above, in the invention according to the first aspect, with respect to the forward delta call plain option, the premium in a case in which the volatility of the forward delta call plain option is used and the premium in a case in which the ATM flat volatility is used are computed, and the deviation between the premiums is computed, with respect to also the forward delta put plain option, the premium in a case in which the volatility of the forward delta put plain option is used and the premium in a case in which the ATM flat volatility is used are computed, and the deviation between the premiums is computed. The correction value is computed by adding the respective deviations after the deviations are weighted according to the component rate of the respective options of the portfolio when the value of the predetermined risk parameter of the portfolio obtained by combining the ATM plain option, the forward delta call plain option, and the forward delta put plain option is equal to the value of the predetermined risk parameter of the currency option to be evaluated, and the premium of the currency option to be evaluated, which is computed using the ATM flat volatility, is corrected by the correction value. Accordingly, since an error of the probability distribution, which is used as an assumption by models (for example, Black=Scholes model, the framework of GK model) can be corrected likewise the technique described in Patent Document 1, and an appropriate value, which accurately reflects the magnitude of a risk of a risk guarantor of currency option, can be obtained as the premium of the currency option to be evaluated.

Further, in the invention according to the first aspect, as the option other than the ATM plain option used to the computation and the like of the correction value, the forward delta call plain option and the forward delta put plain option whose exercise term is the same as the currency option to be evaluated and in which the delta based on the forward rate has the predetermined value. The second acquisition unit obtains the volatility information representing the market values of the volatilities of the forward delta call plain option and the forward delta put plain option, and the exercise price computation unit computes the exercise price of the forward delta call plain option using the volatility of the forward delta call plain option and computes the exercise price of the forward delta put plain option using the volatility of the forward delta put plain option. Therefore, if the currency option to be evaluated is a currency option of a short term less than one year which is traded based on the spot rate, it is necessary to use a discount factor and to use a parameter such as the volatility by converting the parameter from a value based on the spot rate to a value based on the forward rate contrary to the technique described in Patent Document 1.

However, although the discount factor is a product of an interest rate and an interest term, if it is necessary to convert the parameter from the value based on the spot rate to the value based the forward rate in the invention according to the first aspect, since this is the case in which the currency option to be evaluated has a short term, the interest term also has a small value and it does not occur that the discount factor becomes a value as large as 0.5 (50%). Thus, according to the invention described in the first aspect, since it can be prevented that the exercise price of ATM plain option becomes the same as the exercise prices of the forward delta call plain option and the forward delta put plain option, a circumstance, in which the premium of the currency option to be evaluated cannot be computed, can be avoided.

Note that in the invention according to the first aspect, the exercise price computation unit is preferably configured to compute an exercise price in a reference currency in a payment of the premium of the currency option of a first currency and a second currency to be exchanged in the currency option to be evaluated, and the first to third premium computation units are preferably configured to compute the premium in the reference currency as described in, for example a second aspect. In general, since the market value of the volatility is set to a value based on the reference currency, when the second acquisition unit obtains the ATM flat volatility and the volatility information, the exercise price to be computed and the reference currency in the premium match with the reference currency in the market value of the volatility as described above, since the volatility need not be converted due to the difference of the reference currency, the premium of the currency option to be evaluated can be more simply obtained.

Further, in the invention according to the first aspect, the exercise price computation unit as described in, for example, the third aspect, when a cumulative probability density function of a standard normal distribution is N( ), a delta value based on the forward rate is Δ, a volatility of a forward delta plain option is σ, an exercise term of the forward delta plain option is Tₑ, the exercise price computation unit searches and determines a value of a variable D₂ that satisfies the following expression (1) by computation processing of the computer,

[Expression 1]

N(−D₂)−|Δ|·e^{(D}^{₂}^{·σ·√Te+σ}^{²}^{·Te/2)}=0 (1)

when a spot rate is S₀, an interest rate of a reference currency in a payment of the premium of the currency option of a first currency and a second currency to be exchanged in the currency option to be evaluated is r_{f}, an interest rate of a non-reference currency of the first currency and the second currency is r_{d}, and an interest term is T_{d}, the value of the variable D₂ that satisfies the determined expression (1) is substituted into the following expression (2) by computation processing of the computer,

[Expression 2]

K=S₀e^{(rd-rf)·Td}·e^{(-D}^{₂}^{·σ·√Te-σ}^{²}^{·Te/2)} (2)

and then processing for computing an exercise price K are performed with respect to the forward delta call plain option and the forward delta put plain option, thereby computing the exercise prices of the forward delta call plain option and the forward delta put plain option.

Further, in the invention according to the first aspect, the spot rate and the interest rate are also used in the computation of the premium of the currency option and the like. However, considering that these information (in particular, the spot rate) vary in a short cycle, it is preferable to provide the third acquisition unit which obtains spot rates of a first currency and a second currency to be exchanged in the currency option to be evaluated and the interest rates of the first currency and the second currency, from the another computer connected via a communication line, and which stores the obtained spot rates, and the obtained interest rates of the first currency and the second currency in the twelfth storage unit, and to configure the first to third premium computation units, the risk parameter computation unit, the exercise price computation unit, and the component rate computation unit to read the spot rates and the interest rates from the twelfth storage unit and to perform the computations using also the spot rates and the interest rates read from the twelfth storage unit, as described in, for example, the fourth aspect.

A premium computation program for a currency option according to an invention described in a ninth aspect causes a computer including a first storage unit to an eleventh storage unit to function as: a first acquisition unit which obtains a first parameter capable of specifying an exercise date and an exercise term of a currency option to be evaluated and a second parameter representing an exercise price or a delta of the currency option to be evaluated and which stores the obtained first parameter and second parameter in the first storage unit, a second acquisition unit for obtaining an ATM flat volatility representing a market value of a volatility of an ATM plain option whose exercise term is the same as the exercise term of the currency option to be evaluated which is capable of being specified from the first parameter and volatility information representing a market value of a volatility of a forward delta call plain option and a forward delta put plain option in which a delta has a predetermined value based on a forward rate that is an exchange rate uniquely determined from a spot rate, an interest rate and a term at an exercise date of the currency option to be evaluated whose exercise term is the same as the currency option to be evaluated and which is capable of being specified from the first parameter and which stores the obtained ATM flat volatility and volatility information in the second storage unit, a first premium computation unit which reads the second parameter from the first storage unit and reads the ATM flat volatility from the second storage unit, which computes a premium of the currency option to be evaluated using the ATM flat volatility read from the second storage unit and an exercise price of the currency option to be evaluated by computation processing of the computer after the exercise price of the currency option to be evaluated is computed based on a delta of the currency option to be evaluated represented by the second parameter by computation processing of the computer if the second parameter read from the first storage unit represents a delta of the currency option to be evaluated, and which stores the computed premium of the currency option to be evaluated in the third storage unit, a risk parameter computation unit which reads the ATM flat volatility from the second storage unit and reads the premium of the currency option to be evaluated from the third storage unit, which computes a predetermined risk parameter with respect to the currency option to be evaluated using the ATM flat volatility read from the second storage unit and the premium of the currency option to be evaluated read from the third storage unit by computation processing of the computer, and which stores the computed predetermined risk parameter in the fourth storage unit, an exercise price computation unit which reads the ATM flat volatility and the volatility information from the second storage unit, which computes an exercise price of the ATM plain option using the ATM flat volatility read from the second storage unit and computes an exercise price of the forward delta call plain option using a volatility of the forward delta call plain option represented by the volatility information read from the second storage unit by computation processing of the computer, which further computes an exercise price of the forward delta put plain option using a volatility of the forward delta put plain option represented by the volatility information read from the second storage unit by computation processing of the computer, and which stores the computed exercise prices of the respective plain options in the fifth storage unit, a second premium computation unit which reads the ATM flat volatility and the volatility information from the second storage unit and reads the exercise prices of the respective plain options from the fifth storage unit, computes a premium of the ATM plain option using the ATM flat volatility read from the second storage unit and the exercise price of the ATM plain option read from the fifth storage unit and computes a premium of the forward delta call plain option using the volatility of the forward delta call plain option represented by the volatility information read from the second storage unit and the exercise price of the forward delta call plain option read from the fifth storage unit by computation processing of the computer, which further computes a premium of the forward delta put plain option using the volatility of the forward delta put plain option represented by the volatility information read from the second storage unit and the exercise price of the forward delta put plain option read from the fifth storage unit, and which stores the computed premiums of the respective plain options in the sixth storage unit, a component rate computation unit which reads the predetermined risk parameter of the currency option to be evaluated from the fourth storage unit and reads the ATM flat volatility and the volatility information from the second storage unit and reads the premiums of the respective plain options from the sixth storage unit, which computes a component rate of the respective plain options in the portfolio when a value of the predetermined risk parameter with respect to the portfolio obtained by combining the respective plain options determined from the ATM flat volatility and the volatility information read from the second storage unit and the premiums of the respective plain options read from the sixth storage unit is equal to the value of the predetermined risk parameter of the currency option to be evaluated read from the fourth storage unit by computation processing of the computer, and which stores the computed component rate in the seventh storage unit, a third premium computation unit which reads the ATM flat volatility from the second storage unit and reads the exercise prices of the respective plain options from the fifth storage unit, which computes a premium of the forward delta call plain option using the ATM flat volatility read from the second storage unit and the exercise price of the forward delta call plain option read from the fifth storage unit and computes a premium of the forward delta put plain option using the ATM flat volatility read from the second storage unit and the exercise price of the forward delta put plain option read from the fifth storage unit by computation processing of the computer, and which stores the computed premiums of the respective plain options in the eighth storage unit, a deviation computation unit which reads the premiums of the respective plain options from the sixth storage unit and the eighth storage unit, which computes deviations between the premiums read from the sixth storage unit and the premiums read from the eighth storage unit with respect to each of the respective plain options by computation processing of the computer, and which stores the computed deviations in the ninth storage unit, a correction value computation unit which reads the deviations of the respective plain options from the ninth storage unit and reads the component rate from the seventh storage unit, which computes a value obtained by adding the deviations of the respective plain options read from the ninth storage unit after the deviations are weighted according to the component rate read from the seventh storage unit as a correction value to the premium of the currency option to be evaluated by computation processing of the computer, and which stores the computed correction value in the tenth storage unit, a correction unit which reads the premium of the currency option to be evaluated from the third storage unit and reads the correction value from the tenth storage unit, which corrects the premium of the currency option to be evaluated read from the third storage unit by the correction value read from the tenth storage unit by computation processing of the computer, and which stores the premium after amendment in the eleventh storage unit, and an output unit which reads the premium after the correction from the eleventh storage unit and which outputs the premium after the correction as the premium of the currency option to be evaluated.

The premium computation program for the currency option according to the invention described in the ninth aspect is a program for causing the computer including the first storage unit to eleventh storage unit to function as the first acquisition unit, the second acquisition unit, the first premium computation unit, the risk parameter computation unit, the exercise price computation unit, the second premium computation unit, the component rate computation unit, the third premium computation unit, the deviation computation unit, the correction value computation unit, the correction unit, and the output unit. Since the computer functions as the premium computation device of a currency option according to the first aspect by that the computer executes the premium computation program of the currency option according to the ninth aspect, it can be avoided that a premium of a currency option to be evaluated is placed in an incomputable state likewise the invention according to the first aspect.

In a storage medium according to an invention described in a tenth aspect to which a premium computation program for a currency option is stored, the premium computation program causes a computer including a first storage unit to an eleventh storage unit to function as: a first acquisition unit which obtains a first parameter capable of specifying an exercise date and an exercise term of a currency option to be evaluated and a second parameter representing an exercise price or a delta of the currency option to be evaluated and which stores the obtained first parameter and second parameter in the first storage unit, a second acquisition unit which obtains an ATM flat volatility representing a market value of a volatility of an ATM plain option whose exercise term is the same as the exercise term of the currency option to be evaluated which is capable of being specified from the first parameter and volatility information representing a market value of a volatility of a forward delta call plain option and a forward delta put plain option in which a delta has a predetermined value based on a forward rate that is an exchange rate uniquely determined from a spot rate, an interest rate and a term at an exercise date of the currency option to be evaluated whose exercise term is the same as the currency option to be evaluated and which is capable of being specified from the first parameter and storing the obtained ATM flat volatility and volatility information in the second storage unit, a first premium computation unit which reads the second parameter from the first storage unit and reads the ATM flat volatility from the second storage unit, which computes a premium of the currency option to be evaluated using the ATM flat volatility read from the second storage unit and an exercise price of the currency option to be evaluated by computation processing of a computer, after the exercise price of the currency option to be evaluated is computed based on a delta of the currency option to be evaluated represented by the second parameter by computation processing of the computer when the second parameter read from the first storage unit represents a delta of the currency option to be evaluated, and which stores the computed premium of the currency option to be evaluated in the third storage unit, and which stores the computed premium of the currency option to be evaluated in the third storage unit, a risk parameter computation unit which reads the ATM flat volatility from the second storage unit and reads the premium of the currency option to be evaluated from the third storage unit, which computes a predetermined risk parameter with respect to the currency option to be evaluated using the ATM flat volatility read from the second storage unit and the premium of the currency option to be evaluated read from the third storage unit by computation processing of the computer, and which stores the computed predetermined risk parameter in the fourth storage unit, an exercise price computation unit which reads the ATM flat volatility and the volatility information from the second storage unit, which computes an exercise price of the ATM plain option using the ATM flat volatility read from the second storage unit and computes an exercise price of the forward delta call plain option using a volatility of the forward delta call plain option represented by the volatility information read from the second storage unit by computation processing of the computer, which further computes an exercise price of the forward delta put plain option using a volatility of the forward delta put plain option represented by the volatility information read from the second storage unit by computation processing of the computer, and which stores the computed exercise prices of the respective plain options in the fifth storage unit, a second premium computation unit which reads the ATM flat volatility and the volatility information from the second storage unit and reads the exercise prices of the respective plain options from the fifth storage unit, which computes a premium of the ATM plain option using the ATM flat volatility read from the second storage unit and the exercise price of the ATM plain option read from the fifth storage unit and computes a premium of the forward delta call plain option using the volatility of the forward delta call plain option represented by the volatility information read from the second storage unit and the exercise price of the forward delta call plain option read from the fifth storage unit by computation processing of the computer, which further computes a premium of the forward delta put plain option using the volatility of the forward delta put plain option represented by the volatility information read from the second storage unit and the exercise price of the forward delta put plain option read from the fifth storage unit, and which stores the computed premiums of the respective plain options in the sixth storage unit, a component rate computation unit for reading the predetermined risk parameter of the currency option to be evaluated from the fourth storage unit and reads the ATM flat volatility and the volatility information from the second storage unit and reads the premiums of the respective plain options from the sixth storage unit, which computes a component rate of the respective plain options in the portfolio when a value of the predetermined risk parameter with respect to the portfolio obtained by combining the respective plain options determined from the ATM flat volatility and the volatility information read from the second storage unit and the premiums of the respective plain options read from the sixth storage unit becomes equal to the value of the predetermined risk parameter of the currency option to be evaluated read from the fourth storage unit by computation processing of the computer, and which stores the computed component rate in the seventh storage unit, a third premium computation unit which reads the ATM flat volatility from the second storage unit and reads the exercise prices of the respective plain options from the fifth storage unit, which computes a premium of the forward delta call plain option using the ATM flat volatility read from the second storage unit and the exercise price of the forward delta call plain option read from the fifth storage unit and computes a premium of the forward delta put plain option using the ATM flat volatility read from the second storage unit and the exercise price of the forward delta put plain option read from the fifth storage unit by computation processing of the computer, and which stores the computed premiums of the respective plain options in the eighth storage unit, a deviation computation unit which reads the premiums of the respective plain options from the sixth storage unit and the eighth storage unit, which computes deviations between the premiums read from the sixth storage unit and the premiums read from the eighth storage unit with respect to each of the respective plain options by computation processing of the computer, and which stores the computed deviations in the ninth storage unit, a correction value computation unit which reads the deviations of the respective plain options from the ninth storage unit and reads the component rate from the seventh storage unit, which computes a value obtained by adding the deviations of the respective plain options read from the ninth storage unit after the deviations are weighted according to the component rate read from the seventh storage unit as a correction value to the premium of the currency option to be evaluated by computation processing of the computer, and which stores the computed correction value in the tenth storage unit, a correction unit which reads the premium of the currency option to be evaluated from the third storage unit and reads the correction value from the tenth storage unit, which corrects the premium of the currency option to be evaluated read from the third storage unit by the correction value read from the tenth storage unit by computation processing of the computer, and which stores the premium after correction in the eleventh storage unit, and, an output unit which reads the premium after the correction from the eleventh storage unit and which outputs the premium after the correction as the premium of the currency option to be evaluated.

The storage medium of the invention according to a tenth aspect stores the premium computation program according to the invention described in the ninth aspect, that is, with the program for causing the computer including the first storage unit to eleventh storage unit to function as the first acquisition unit, the second acquisition unit, the first premium computation unit, the risk parameter computation unit, the exercise price computation unit, the second premium computation unit, the component rate computation unit, the third premium computation unit, the deviation computation unit, the correction value computation unit, the correction unit, and the output unit. Since the computer functions as the premium computation device of the currency option according to the first aspect by that the computer reads the premium computation program of the currency option from the storage medium and executes the premium computation program, it can be avoided that a premium of a currency option to be evaluated is placed in an incompatible state.

### Effects of the Invention

As described above, the invention obtains the ATM flat volatility representing the market value of the volatility of the ATM plain option whose exercise term is the same as the currency option to be evaluated and the volatility information representing the market values of the volatilities of the forward delta call plain option and the forward delta put plain option whose exercise terms are the same as the currency option to be evaluated and in which the delta based on the forward rate has the predetermined value, computes the exercise price of the forward delta call plain option using the volatility of the forward delta call plain option represented by the volatility information and computes the exercise price of the forward delta put plain option using the volatility of the forward delta put plain option represented by the volatility information, and computes the premiums of the forward delta call plain option and the forward delta put plain option, the correction value to the premium of the currency option to be evaluated, and the like. Accordingly, the invention has an excellent effect of avoiding that a premium of a currency option to be evaluated is placed in an incomputable state.

### BRIEF DESCRIPTION OF THE DRAWINGS

FIG. 1 is a block diagram showing a schematic configuration of a computer according to an embodiment.

FIGS. 2A and 2B are flowcharts showing contents premium computation processing.

FIG. 3 is a flowchart showing contents of exercise price computation processing.

FIG. 4 is a flowchart showing contents of a solution search processing.

FIG. 5 is a graph explaining a 25 delta call plain option.

FIG. 6 is a graph explaining a 25 delta put plain option.

FIGS. 7A, 7B are graphs explaining digital touch options.

### BEST MODE FOR CARRYING OUT THE INVENTION

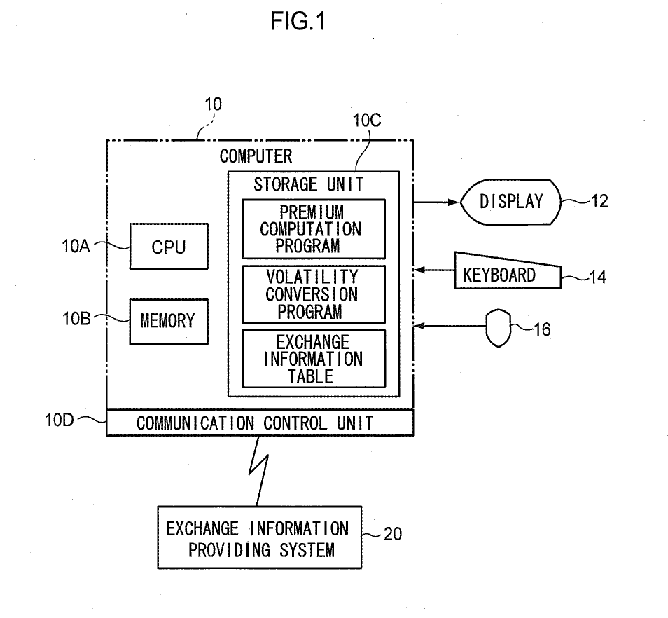

An example an embodiment of the present invention will be explained below in detail referring to the drawings. FIG. 1 shows a computer 10 according to the embodiment. The computer 10 includes a CPU 10A, a memory 10B composed of a ROM, a RAM, and the like, a non-volatile storage unit 10C composed of a Hard Disk Drive (HDD), a flash memory and the like, and a communication control unit 10D. Further, a display 12 composed of a CRT, an LCD, and the like, a keyboard 14, and a mouse 16 are connected to the computer 10 as various peripheral equipments. Further, the communication control unit 10D of the computer 10 is connected to an exchange information providing system 20 via a communication line. The exchange information providing system 20 is a system for delivering present market values of various parameters (for example, a spot rate, an interest rate, a volatility, and the like) in an exchange rate to the outside as exchange information and composed of a single computer or plural computers interconnected via a network such as a LAN and the like.

The storage unit 10C of the computer 10 is provided with an exchange information table, to which the exchange information obtained from the exchange information providing system 20 is registered, and installed with also a premium computation program for performing premium computation processing to be described later and with a volatility conversion program having a function for converting a volatility at a spot rate to a volatility at a forward rate. The premium computation program corresponds to a premium computation program of a currency option according to the invention, the computer 10 functions as a premium computation device of a currency option according to the invention by that the CPU 10A executes the premium computation program, the memory 10B is used as a first storage unit to eleventh storage unit according to the invention, and a storage unit 12C is used as a twelfth storage unit according to the fourth aspect. Note that the computer 10 corresponds to a computer according to the ninth and tenth claims. Although the computer 10 may be composed of, for example, a personal computer (PC), the computer according to the ninth and tenth claims is not limited to the PC and may be, for example, a workstation, a general purpose host computer, and the like.

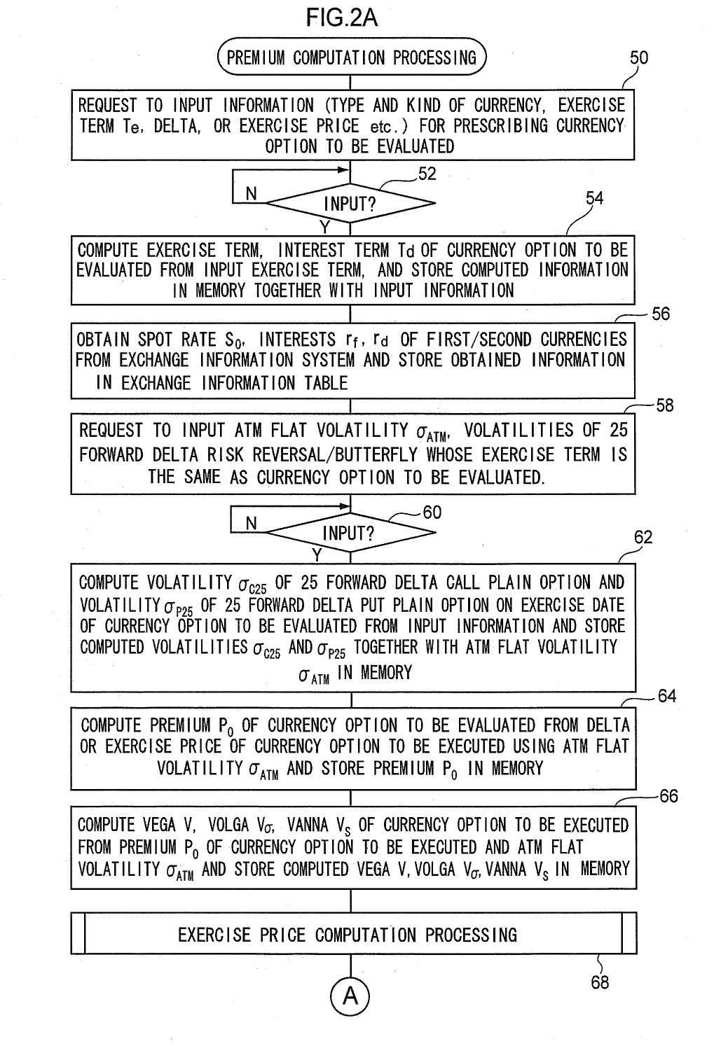

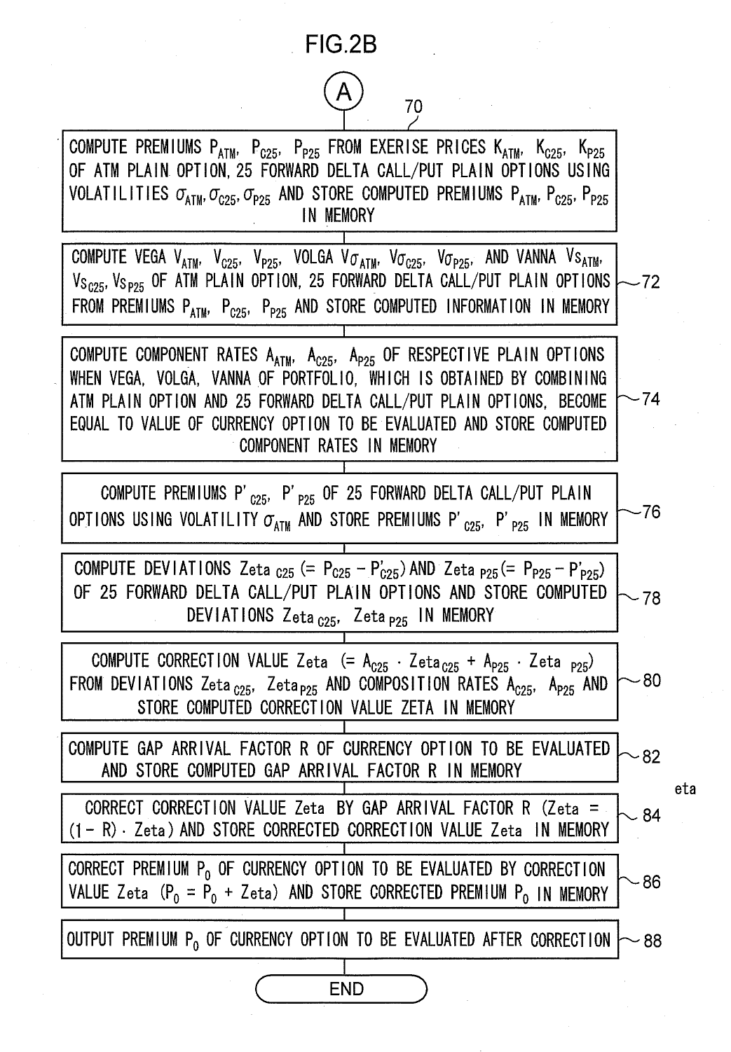

Next, as an operation of the embodiment, premium computation processing, which is realized by the computer 10 by that the CPU 10A executes the premium computation program when the keyboard 14 and the mouse 16 has been operated by a user and a computation of a premium of a currency option to be evaluated has been instructed, will be explained referring to FIGS. 2A and 2B.

In the premium computation processing, first, at step 50, the user inputs the respective information with respect to the currency option to be evaluated in response to a message displayed on the display 12 to request to input various information for prescribing a currency option to be evaluated. At next step 52, whether or not the respective information are input is determined, and step 52 is repeated until the determination becomes YES. When the user recognizes that the message is displayed on the display 12, the user operates the keyboard 14 and the like, and inputs information representing a type of the currency option to be evaluated (for example, a type of an option such as a plain option/reverse knock out option, and the like, whether the option is any of a call and a put, and the like), information representing types of a first currency and a second currency which are used as objects of exchange in the currency option to be evaluated (for example, the US dollar, the Japanese yen, and the like), an exercise term Tₑ (a term from an evaluation date (this day) of the currency option to an exercise date of the currency option) of the currency option to be evaluated, and the like as information for prescribing the currency option to be evaluated and inputs also a delta value of the currency option to be evaluated (rate of change of option value to change of spot rate=first-order differentiated value in exchange spot rate of option premium) Δ₀ or an exercise price K₀ of the currency option to be evaluated. Further, when the currency option to be evaluated is a knock out option, a knock out price K_{V} is also input by the user.

When the respective information has been input by that the keyboard 14 and the like has been operated by the user, determination is made YES at step 52, and a processing goes to step 54. At step 54, the exercise date of the currency option to be evaluated and an interest term T_{d} of the currency option to be evaluated (a term from a delivery date of a fund (ordinarily, a date after two business days from an evaluation date) to a delivery date of an exchange (ordinarily, a date after two business days from an exercise date of the currency option) are computed based on an exercise term Tₑ input by the user, and the computed interest term T_{d} is stored in the memory 10B together with the respective information input by the user. Note that, although a case, in which a reverse knock out option is designated as a type of the currency option to be evaluated and a premium of reverse knock out option is computed as the premium of the currency option to be evaluated, will be explained below, the currency option to be evaluated is not limited to the reverse knock out option in the invention and may be other exotic option or plain option.

At next step 56, the types of the first currency and the second currency are read from the memory 10B and transmitted to the exchange information providing system 20, thereby enquiring present spot rates S₀ of the first currency and the second currency, a present interest rate r_{f} of the first currency, and a present interest rate r_{d} of the second currency to the exchange information providing system 20, and the spot rate S₀ and the interest rates r_{f}, r_{d} received from the exchange information providing system 20 are stored in an exchange information table disposed to the storage unit 10C.

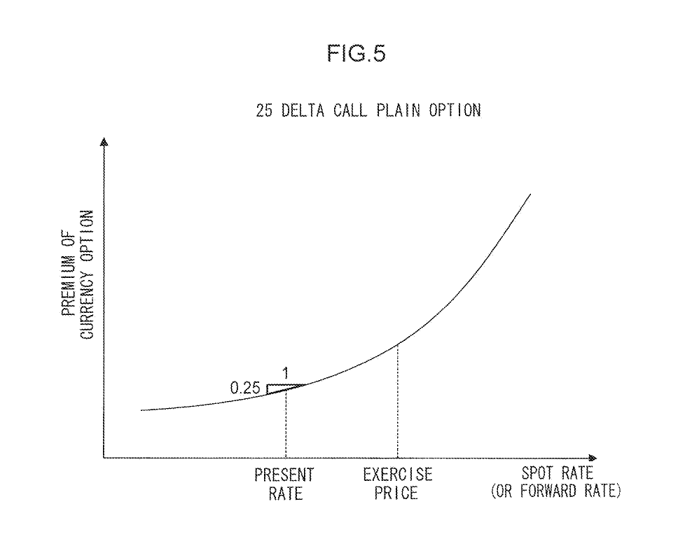

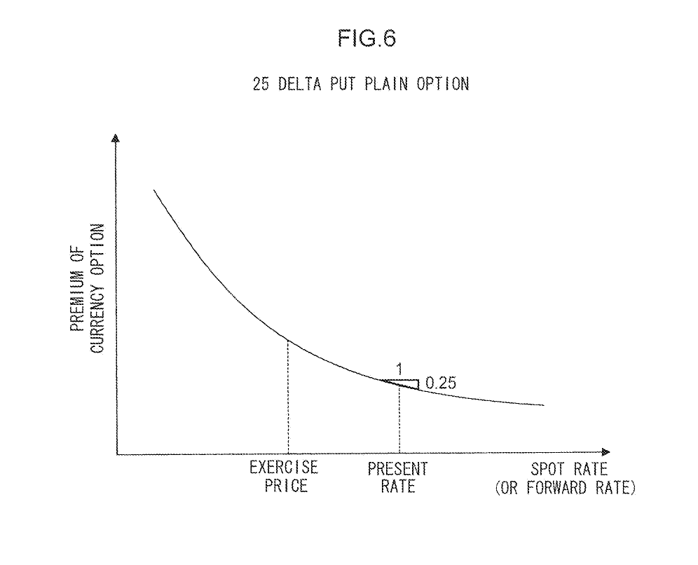

In the premium computation processing according to the embodiment, the premium of the currency option to be evaluated is computed based on the information of a plain option traded in a currency option market, which will be described later in detail. In the embodiment, three types of plain options which have a high fluidity in a market, that is, an ATM plain option, a 25 delta call plain option, and a 25 delta put plain option are used as the plain option. The ATM plain option is an option in which delta values of a call and a put have the same exercise price. Further, as shown in FIG. 5, the 25 delta call option is a call option in which an exercise price is set at a point where a delta becomes 25%, and, as shown in FIG. 6, the 25 delta put option is a put option in which an exercise price is set at a point where a delta becomes 25%. In these plain options, a transaction is performed quoting a volatility, and a premium amount of money, which is computed from a volatility and variables (spot rate, interest rate, and the like) at the time of transaction using GK model, is delivered. That is, the values of the volatilities of these plain options can be obtained from a market.

Therefore, at next step 58, the exercise term Tₑ of the currency option to be evaluated is read from the memory 10B and the exercise term Tₑ and a message which requests to input an ATM flat volatility σ_{ATM}, a volatility Δσ_{RR} of a 25 delta risk reversal, and a volatility Δσ_{BF} of a 25 delta butterfly whose exercise term is the same as the displayed exercise term Tₑ (whose exercise term is the same as the currency option to be evaluated) are displayed on the display 12 and thereby the user is caused to input the respective information. Note that, in the premium computation processing according to the embodiment, the premium of the currency option to be evaluated is computed by applying the first currency (when the first/second currencies are the US dollar/the Japanese yen, the first currency is the US dollar) as a premium payment currency and applying a forward rate as a reference rate, and, at step 58 described above, the user is caused to input a volatility of a currency option which is paid by the first currency at the forward rate as the reference rate in more detail. At next step 60, whether or not the respective information are input is determined, and step 60 is repeated until the determination becomes YES.

When the message is displayed on the display 12, the user performs an operation for obtaining market values of the ATM flat volatility σ_{ATM}, the volatility Δσ_{RR} of the 25 delta risk reversal, and the volatility Δσ_{BF} of the 25 delta butterfly whose exercise term is the same as the displayed exercise term Tₑ (these market values can be also obtained from the exchange information providing system 20 by on line) and inputting the obtained market values via the keyboard 14. However, in currency options traded in a market, a currency option of a long term longer than one year is traded based on the forward rate (for example, “25 delta option” designates an option in which a delta value becomes 25 (=0.25) based on the forward rate (hereinafter, the option is called a “25 forward delta” option), and a market value of a corresponding volatility is a volatility paid by the first currency based on the forward rate. In contrast, a currency option of a short term less than one year is traded based on a spot rate (for example, “25 delta option” designates an option in which a delta value becomes 25 (=0.25) based on the spot rate (hereinafter, the option is called “a 25 spot delta” option), and a market value of a corresponding volatility is a volatility based on the spot rate although the market value is a volatility paid by the first currency.

Therefore, in the embodiment, a volatility conversion program, which has a function for converting a volatility based on the spot rate to a volatility based on the forward rate, is installed to the storage unit 10C of the computer 10. If the exercise term Tₑ of the currency option to be evaluated is a relatively short term (for example, less than one year) in which a transaction in a market is performed based on the spot rate and a market value of an obtained volatility is a value based on the spot rate, the user causes CPU 10A to execute the volatility conversion program and inputs the obtained volatility based on the spot rate via the keyboard 14 and thereby converting the volatility based on the spot rate to a volatility based on the forward rate by the volatility conversion program. Then, the user inputs the volatility based on the forward rate via the keyboard 14 after the volatility is converted and thereby delivering the volatilities σ_{ATM}, Δσ_{RR}, Δσ_{BF}, which are paid by the first currency and are based on the forward rate, to the premium computation processing (FIGS. 2A and 2B).

After the market values of the volatilities (the volatilities σ_{ATM}, Δσ_{RR}, Δσ_{BF} which are paid by the first currency and are based on the forward rate) are input by the user, the determination at step 60 becomes YES and the processing goes to step 62. A market value of a volatility which can be obtained with respect to the 25 delta is the volatility Δσ_{RR} of the delta risk reversal, which is a deviation between the volatility of the 25 delta call plain option and the volatility of the 25 delta put plain option, and the volatility Δσ_{BF} of the 25 delta butterfly, which is a deviation between an average value of the volatility of the 25 delta call plain option and the volatility of the 25 delta put plain option volatility and the volatility of the ATM plain option. Accordingly, at step 62, the volatility σ_{C25} of the 25 forward delta call plain option and the volatility σ_{P25} of the 25 forward delta put plain option are computed, by computing next expressions (3), (4) using the respective input information.

σ_{C25}=σ_{ATM}+Δσ_{BF}+Δσ_{RR}/2 (3)

σ_{P25}=σ_{ATM}+Δσ_{BF}−Δσ_{RR}/2 (4)

The computed volatility σ_{C25} of the 25 forward delta call plain option and the computed volatility σ_{P25} of the 25 forward delta put plain option are stored in the memory 10B together with the volatility of the ATM plain option input by the user.

Note that although the market value of the volatility is input by the user in the above case, the invention is by no means limited thereto. However, a list of volatilities may be obtained from the exchange information providing system 20 and the volatilities of the respective plain options whose exercise term is the same as the currency option to be evaluated may be extracted from the list. Further, the exercise term Tₑ of the currency option to be evaluated may be notified to the exchange information providing system 20 and the volatilities of the respective plain options whose exercise term is the same as the notified exercise term Tₑ may be inquired to the exchange information providing system 20, and relevant volatilities may be received from the exchange information providing system 20. In the modes, if the market value of the obtained volatility is a value based on the spot rate, it is preferable to automatically start the volatility conversion program, to automatically convert the volatility based on the spot rate to a volatility based on the forward rate, and to compute the expressions (3), (4).

At next step 64, the spot rate S₀ and the interest rates r_{f}, r_{d} are read from the exchange information table and a delta Δ₀ or the exercise price K₀, the exercise term Tₑ, the interest term T_{d} of the currency option to be evaluated, the σ_{ATM} flat volatility r_{ATM} are read from the memory 10B, a premium P₀ of the currency option to be evaluated is computed using the respective read information, and the computed premium P₀ is stored in the memory 10B. In the framework of GK model, a premium P of the reverse knock out option is shown in a next expression (5) regardless that the reverse knock out option is the call option or the put option.

$$\begin{matrix} [ Expression 3 ] & \\ P = {S}_{0} \cdot {e}^{- rf \cdot Td} \cdot N ( {d}_{1} ) - K \cdot {e}^{- rd \cdot Td} \cdot N ( {d}_{z} ) - \{ {S}_{0} \cdot {e}^{- rf \cdot Td} \cdot N ( {d}_{3} ) - K \cdot {e}^{- rd \cdot Td} \cdot N ( {d}_{4} ) \} - \{ {( \frac{{S}_{0}}{{K}_{V}} )}^{- ξ - 1} \cdot {S}_{0} \cdot {e}^{- rf \cdot Td} \cdot N ( {d}_{5} ) - {( \frac{{S}_{0}}{{K}_{V}} )}^{- ξ + 1} \cdot K \cdot {e}^{- rf \cdot Td} \cdot N ( {d}_{6} ) \} + \{ {( \frac{{S}_{0}}{{K}_{V}} )}^{- ξ - 1} \cdot {S}_{0} \cdot {e}^{- rf \cdot Td} \cdot N ( {d}_{7} ) - {( \frac{{S}_{0}}{{K}_{V}} )}^{- ξ + 1} \cdot K \cdot {e}^{- rf \cdot Td} \cdot N ( {d}_{8} ) \} & ( 5 )\end{matrix}$$

However, d1-d8, ξ in the expression (5) are shown in a next expression (6).

$$\begin{matrix}[ Expression 4 ] & \\ \begin{matrix}{d}_{1} = \frac{ln ( \frac{{S}_{0}}{K} ) + ( {r}_{d} - {r}_{f} ) \cdot {T}_{d} + \frac{{σ}^{2} \cdot {T}_{e}}{2}}{σ \sqrt{{T}_{e}}} \\ {d}_{2} = \frac{ln ( \frac{{S}_{0}}{K} ) + ( {r}_{d} - {r}_{f} ) \cdot {T}_{d} - \frac{{σ}^{2} \cdot {T}_{e}}{2}}{σ \sqrt{{T}_{e}}} \\ {d}_{3} = \frac{ln ( \frac{{S}_{0}}{{K}_{V}} ) + ( {r}_{d} - {r}_{f} ) \cdot {T}_{d} + \frac{{σ}^{2} \cdot {T}_{e}}{2}}{σ \sqrt{{T}_{e}}} \\ {d}_{4} = \frac{ln ( \frac{{S}_{0}}{{K}_{V}} ) + ( {r}_{d} - {r}_{f} ) \cdot {T}_{d} - \frac{{σ}^{2} \cdot {T}_{e}}{2}}{σ \sqrt{{T}_{e}}} \\ {d}_{5} = \frac{ln ( \frac{{K}_{V}^{2}}{K \cdot {S}_{0}} ) + ( {r}_{d} - {r}_{f} ) \cdot {T}_{d} + \frac{{σ}^{2} \cdot {T}_{e}}{2}}{σ \sqrt{{T}_{e}}} \\ {d}_{6} = \frac{ln ( \frac{{K}_{V}^{2}}{K \cdot {S}_{0}} ) + ( {r}_{d} - {r}_{f} ) \cdot {T}_{d} - \frac{{σ}^{2} \cdot {T}_{e}}{2}}{σ \sqrt{{T}_{e}}} \\ {d}_{7} = \frac{ln ( \frac{{K}_{V}}{{S}_{0}} ) + ( {r}_{d} - {r}_{f} ) \cdot {T}_{d} + \frac{{σ}^{2} \cdot {T}_{e}}{2}}{σ \sqrt{{T}_{e}}} \\ {d}_{8} = \frac{ln ( \frac{{K}_{V}}{{S}_{0}} ) + ( {r}_{d} - {r}_{f} ) \cdot {T}_{d} - \frac{{σ}^{2} \cdot {T}_{e}}{2}}{σ \sqrt{{T}_{e}}} \\ ξ = \frac{2 \cdot ( {r}_{d} - {r}_{f} ) \cdot {T}_{d}}{{σ}^{2} \cdot {T}_{e}}\end{matrix} \} & ( 6 )\end{matrix}$$

In the expressions (5), (6), K is an exercise price, K_{V} is a knock out price at which the right of option is extinguished, and N( ) is a cumulative frequency function of a standard normal distribution. The premium P₀ of the currency option to be evaluated, which is the reverse knock out option, can be computed by computing the expressions (5), (6) using the exercise price K₀ of the currency option to be evaluated as the exercise price K and the ATM flat volatility σ_{ATM} as a volatility σ. Note that if the exercise price K₀ of the currency option to be evaluated is input by the user as information for prescribing the currency option to be evaluated, the input exercise price K₀ may be used as it is as the exercise price K in the expressions (5), (6). However, if a delta value Δ₀ of the currency option to be evaluated is input in place of the exercise price K₀, the premium P₀ of the currency option to be evaluated can be computed by substituting the exercise price K₀ of the currency option to be evaluated for the expressions (5), (6) after the exercise price K₀ is computed by substituting the input delta value Δ₀ for a predetermined operation expression.

Specifically, computation of the exercise price K₀ from the delta value Δ₀ of the currency option to be evaluated can be specifically realized by, for example, computing a variable d₂ by substituting the delta value Δ₀ of the currency option to be evaluated in place of a delta value “0.25” in an expression (9) or (11) described below and then computing the exercise price K by substituting the computed variable d₂ for an expression (10) or (12) described below.

At next step 66, the spot rate S₀ is read from the exchange information table and the premium P₀ of the currency option to be evaluated, which is computed at step 64, and the ATM flat volatility σ_{ATM} are read from the memory 10B. Then, a vega V, a volga V_{σ}, a vanna Vₛ of the currency option to be evaluated are computed, as predetermined risk parameters of the currency option to be evaluated by substituting the respective read information for a next expression (7), and the computed vega V, volga V_{σ}, vanna Vₛ are stored in the memory 10B.

$$\begin{matrix}[ Expression 5 ] & \\ V = \frac{\partial P}{\partial σ} {V}_{σ} = \frac{{\partial }^{2} P}{\partial {σ}^{2}} {V}_{S} = \frac{{\partial }^{2} P}{\partial σ \partial {S}_{0}} & ( 7 )\end{matrix}$$

At next step 68, exercise price computation processing is performed to compute exercise prices of the ATM plain option, the 25 forward delta call plain option, and the 25 forward delta put plain option.

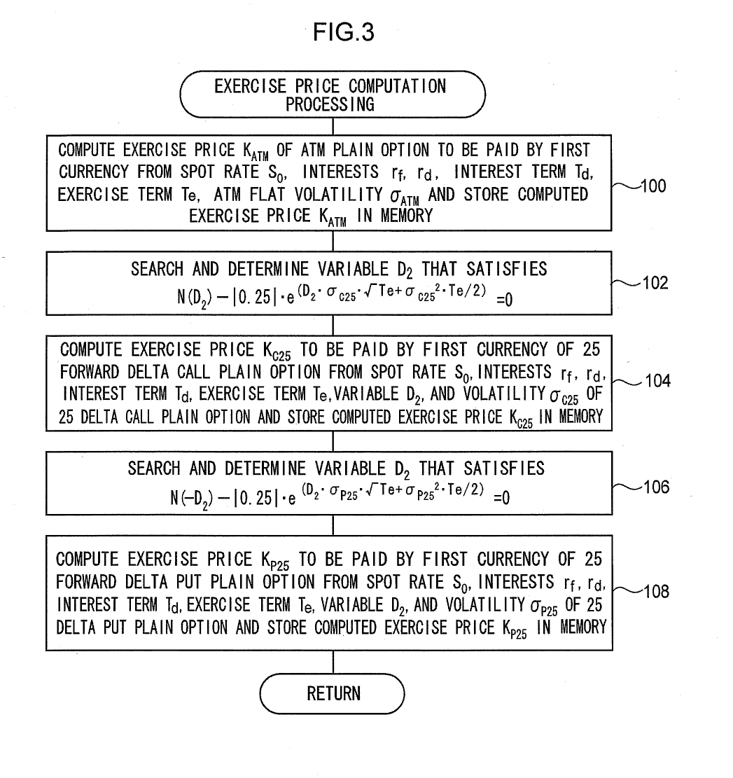

The exercise price computation processing will be explained referring to FIG. 3. First, at step 100, the spot rate S₀ is read from the exchange information table and the interest term T_{d}, the exercise term Tₑ, the ATM flat volatility σ_{ATM} are read from the memory 10B. An the exercise price K_{ATM} of the ATM plain option paid by the first currency is computed by substituting the respective read information for a next expression (8), and the computed exercise price K_{ATM} of the ATM plain option is stored in the memory 10B.

[Expression 6]

K_{ATM}=S₀·e^{(rf-rf)·Td}·e^{-(σ}^{_{ATM}}^{²}^{·Te/2)} (8)

At next steps 102, 104, an exercise price of the 25 forward delta call plain option is computed. More specifically, first, at step 102, the volatility σ_{C25} and the exercise term Tₑ of the 25 forward delta call plain option are read from the memory 10B, the respective read information are substituted for the next expression (9), and the variable D₂, which satisfies the expression (9) for which the volatility σ_{C25} and the exercise term Tₑ are substituted, is determined.

[Expression 7]

N(D₂)−|0.25|·e^{(D}^{₂}^{·σ}^{_{C25}}^{·√Te+σ}^{_{C25}}^{²}^{·Te/2)}=0 (9)

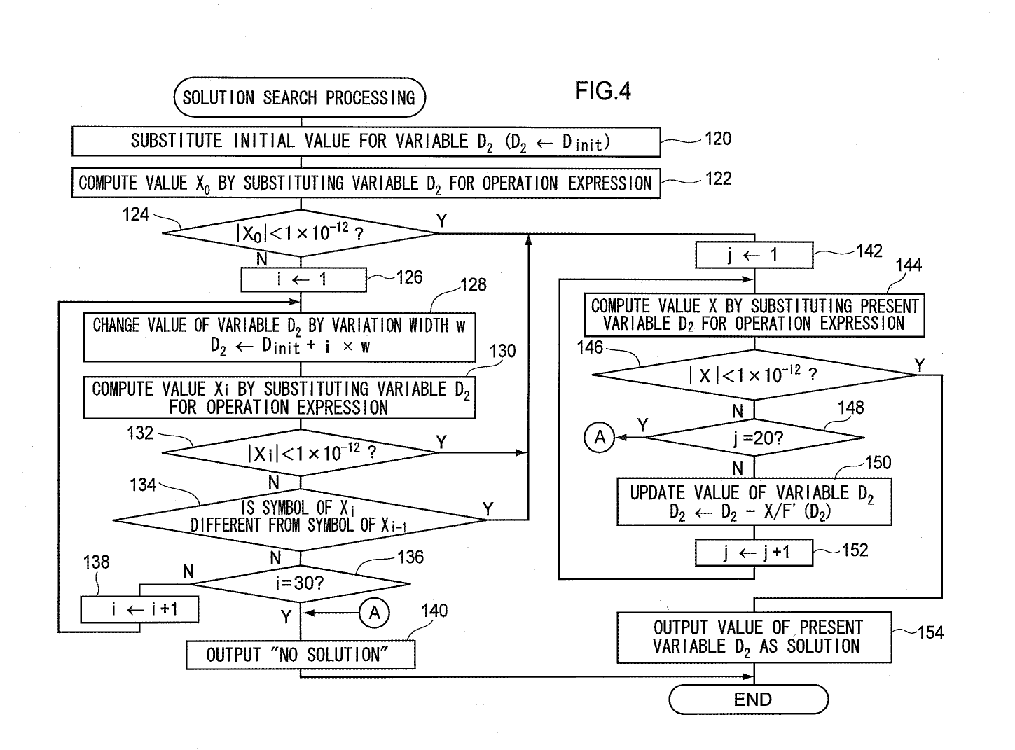

Note that N( ) in the expression (9) is the cumulative frequency function of the standard normal distribution, and “0.25” in the expression (9) represents a value of a forward delta. Since a variable D₂ which satisfies the expression (9) cannot be directly computed, at step 102, a value of the variable D₂ which satisfies the expression (9) is searched by repeatedly determining whether or not the expression (9) is satisfied while changing the value of the variable D₂. An example of a processing for searching the value of the variable D₂ will be explained below referring to FIG. 4.

In a solution search processing shown in FIG. 4, after the value of the variable D₂ is restricted at step 120 to step 138, a solution of the variable D₂ is searched by applying Newton method at step 142 to step 152. More specifically, first, at step 120, a predetermined initial value Dᵢₙᵢₜ is substituted for the variable D₂. Note that a value of, for example, about “10” can be used as the initial value Dᵢₙᵢₜ. At step 122, the variable D₂ is substituted for the operation expression (the expression (9)), and a value X₀ of a right side of the operation expression is computed. At next step 124, whether or not an absolute value of the value X₀, which is obtained by the computation at step 122, is sufficiently near to 0 is determined. In the example of FIG. 4, whether or not |X₀| is smaller than 1×10⁻¹² is determined. If the determination is YES, the restriction of the value of the variable D₂ is finished and the processing goes to step 142, whereas if the determination is NO, 1 is substituted for a counter i at step 126.

At next step 128, a value, which is obtained by adding the initial value Dᵢₙᵢₜ it to a product of the counter i and a variation width w is substituted for the variable D₂ (D₂→Dᵢₙᵢₜ+i×w), thereby changing the value of the variable D₂ by the variation width w. Note that a value of, for example, about “1”, can be used as the variation width w. At step 130, the variable D₂ whose value is changed at step 128 is substituted for the operation expression (the expression (9)), and a value Xᵢ of the right side of the operation expression is computed. At next step 132, whether or not an absolute value of the value Xᵢ, which is obtained by the computation at step 130, is sufficiently near to 0 is determined. In the example of FIG. 4, whether or not |Xᵢ| is smaller than 1×10⁻¹² is determined, and if the determination is YES, the restriction of the value of the variable D₂ is finished and the processing goes to step 142, whereas if the determination is NO, the processing goes to step 134, and whether or not a symbol of the value Xᵢ is different from a symbol of a value Xᵢ₋₁ which is a previous value of Xᵢ. If the determination is YES, since it can be judged that the solution of the variable D₂ exists between a value corresponding to a present i and a value corresponding to (i−1), the restriction of the value of the variable D₂ is finished and the processing goes to step 142.

Further, if the determination at step 134 is NO, the processing goes to step 136 and determines whether or not a value of the counter i becomes 30. If the determination is NO, after the value of the counter i is incremented by 1 at step 138, the processing returns to step 128. With the operations, step 128 to step 138 are repeated until the determination at any of steps 132, 134, 136 becomes YES. If any of the determinations at steps 132, 134 does not become YES until the value of the counter i becomes 30, the determination at step 136 is made YES, the processing goes to step 140, and the processing is finished by outputting that the variable D₂ does not have a solution. The solution of the variable D₂ in the case can be searched by applying a different method (for example, a bisection method and the like). Note that it is needless to say that a value other than “30” described above may be applied as an upper limit value of the number of times of a loop of step 128 to step 138.

In contrast, if the determination at any of steps 124, 132, 134 is YES, first, 1 is substituted for a counter j at step 142. Further, at step 144, a present variable D₂ is substituted for the operation expression (the expression (9)), and a value X of the right side of the operation expression is computed. At next step 146, whether or not an absolute value of the value X, which is obtained by the computation at step 144, is a value (|Xᵢ|<1×10⁻¹²) sufficiently near to 0 is determined. If the determination at previous step 124 or step 132 is YES, the determination is made YES. In the case, since it can be judged that a present value of the variable D₂ is the solution of the variable D₂, the value of the present variable D₂ is output as the solution at step 154 (stored in the memory 10B), and the processing is finished. In contrast, if the determination at step 146 is NO, the processing goes to step 148 and determines whether or not a value of the counter j becomes 20. If the determination is NO, the processing goes to step 150 and updates the value of the variable D₂ according to the next expression (10).

D₂←D₂−X/F′(D₂) (10)

However, F′(D₂) in the expression (10) can be shown by the next expression (11).

[Expression 8]

F′(D₂)=e^{((-D}^{₂}^{²}^{/2)/√(2π))}−0.25·σ·√Te·e^{(-D}^{₂}^{·Υ·√Te-σ}^{²}^{·Te/2)} (11)

Note that since a search of the value of the variable D₂ at the time is to compute the exercise price of the 25 forward delta call plain option, the volatility σ_{C25} of the 25 forward delta call plain option can be used as a volatility a in the expression (11).

At next step 152, a value of the counter j is incremented by 1, and the processing returns to step 144. With the operations, step 144 to step 152 are repeated until the determination at any of steps 146, 148 becomes YES. If any of the determinations at steps 146 does not become YES until the value of the counter j becomes 20, the determination at step 148 is made YES, the processing goes to step 140, and the processing is finished by outputting that the variable D₂ does not have a solution. Note that it is needless to say that a value other than “20” described above may be applied as an upper limit value of the number of times of a loop of step 144-step 152. Further, although the determination at step 146 is NO at the beginning, if the determination at step 146 is YES thereafter before the determination at step 148 is made YES, the value of the present variable D₂ is output as the solution at step 154 (stored in the memory 10B), and the processing is finished. The value of the variable D₂ which satisfies the expression (9) can be obtained by performing the processing described above.

In exercise price computation processing (FIG. 3), subsequently, at step 104, the spot rate S₀ and the interest rates r_{f}, r_{d} are read from the exchange information table, and the interest term T_{d}, the exercise term Tₑ, the variable D₂, and the volatility σ_{C25} of the 25 forward delta call plain option are read from the memory 10B, and the respective read information are substituted for the next expression (12), respectively. With the operations, an exercise price K_{C25} of the 25 forward delta call plain option paid by the first currency is computed, and the computed exercise price K_{C25} of the 25 forward delta call plain option paid by the first currency is stored in the memory 10B.

[Expression 9]

K_{C25}=S₀·e^{(rd-rf)·Td}·e^{(-D}^{₂}^{·σ}^{_{C25}}^{·Te-σ}^{_{C25}}^{²}^{·Te/2)} (12)

Subsequently, at steps 106, 108, an exercise price of the 25 forward delta put plain option is computed. More specifically, at step 106, the volatility σ_{P25} and the exercise term Tₑ of the 25 forward delta call plain option are read from the memory 10B, the respective read information are substituted for a next expression (13), and the variable D₂, which satisfies the expression (13) for which the volatility σ_{P25} and the exercise term Tₑ are substituted, is determined.

[Expression 10]

N(−D₂)−|0.25|e^{(D}^{₂}^{·σ}^{_{P25}}^{·√Te+σ}^{_{P25}}^{²}^{·Te/2)=}0 (13)

Note that N( ) in the expression (13) is the cumulative frequency function of the standard normal distribution, and “0.25” in the expression (13) represents also the value of the forward delta. Since a value of the variable D₂ which satisfies the expression (13) cannot be also directly computed, the value of the variable D₂ which satisfies the expression (13) is searched by performing the solution search processing described above (FIG. 4) also at step 106 (however, the volatility σ_{P25} of the 25 forward delta put plain option is used as the volatility a in the previous expression (11)).

At step 108, the spot rate S₀ and the interest rates r_{f}, r_{d} are read from the exchange information table and the interest term T_{d}, the exercise term Tₑ, the variable D₂, the volatility σ_{P25} of the 25 delta put plain option are read from the memory 10B, and the respective read information are substituted for a next expression (14), respectively. With the operations, an exercise price K_{P25} of the 25 forward delta put plain option paid by the first currency is computed, and the computed exercise price K_{P25} of the 25 forward delta put plain option paid by the first currency is stored in the memory 10B.

[Expression 11]

K_{P25}=S₀·e^{(rd-rf)·Td}·e^{(-D}^{₂}^{·σ}^{_{P25}}^{·√Te-σ}^{_{P25}}^{²}^{·Te/2)} (14)

When the exercise prices of the ATM plain option, the 25 forward delta call plain option and the 25 forward delta put plain option has been computed by the exercise price computation processing, the processing goes to step 70 of premium computation processing (FIGS. 2A and 2B).

At step 70, the spot rate S₀ and the interest rates r_{f}, r_{d} are read from the exchange information table and the interest term T_{d}, the exercise prices K_{ATM}, K_{C25}, K_{P25} of the ATM plain option, the 25 forward delta call plain option, and the 25 forward delta put plain option, the ATM flat volatility σ_{ATM}, and the volatilities σ_{C25}, σ_{P25} of the 25 forward delta call plain option and the 25 forward delta put plain option are read from the memory 10B. If an option to be computed is the call option, the respective read information are substituted for an expression (15), and if an option to be computed is the put option, the respective read information are substituted for an expression (16), premiums P_{ATM}, P_{C25}, P_{P25} of the ATM plain option, the 25 forward delta call plain option, and the 25 forward delta put plain option are computed, and the computed premiums P_{ATM}, P_{C25}, P_{P25} are stored in the memory 10B.

[Expression 12]

P=S₀·e^{-rf·Td}·N(d₁)−K·e^{-rf·Td}·N(d₂) (15)

P=S₀·e^{-rf·Td}·{N(d₁)−1}−K·e^{-rf·Td}·{N(d₂)−1} (16)

Note that in the computation at step 70, when the premium P_{C25} of the 25 forward delta call plain option is computed, the volatility σ_{C25} of the 25 forward delta call plain option is used as a volatility, and when the premium P_{P25} of the 25 forward delta put plain option is computed, the volatility σ_{P25} of the 25 forward delta put plain option is used as a volatility.

Subsequently, at step 70, the spot rates S₀ are read from the exchange information table, and the premiums P_{ATM}, P_{C25}, P_{P25} and the volatilities σ_{ATM}, σ_{C25}, σ_{P25} of the ATM plain option, the 25 forward delta call plain option, and the 25 forward delta put plain option are read from the memory 10B. A vega V_{ATM}, a volga V_{σATM}, a vanna Vs_{ATM} of the ATM plain option, a vega V_{C25}, a volga V_{σC25}, a vanna Vs_{C25} of the 25 forward delta call plain option, and a vega V_{P25}, a volga V_{σP25}, a vanna Vs_{P25} of the 25 forward delta put plain option are computed, by substituting the respective read information for the previous expression (7), respectively, and the vega V_{ATM}, V_{C25}, V_{P25}, the volga V_{σATM}, Vσ_{C25}, V_{σP25}, and the vanna Vs_{ATM}, Vs_{C25}, Vs_{P25} which are computed are stored in the memory 10B.

At next step 74, the vega V, the volga V_{σ}, and the vanna Vₛ of the currency option to be evaluated, which are computed at previous step 66, are read from the memory 10B and the vega V_{ATM}, V_{C25}, V_{P25}, the volga V_{σATM}, V_{σC25}, V_{σP25}, and the vanna Vs_{ATM}, Vs_{C25}, Vs_{P25} of the ATM plain option, the 25 forward delta call plain option, and the 25 forward delta put plain option, which are computed at step 70, are read from the memory 10B. Component rates (rates of amounts of money) A_{ATM}, A_{C25}, A_{P25} of the respective plain options are computed when a vega, a volga, a vanna of a portfolio, which is obtained by combining the ATM plain option, the 25 forward delta call plain option, and the 25 forward delta put plain option, become equal to the vega V, the volga V_{σ}, the vanna Vₛ of the currency option to be evaluated (when relationships shown in a next expression (17) are satisfied), and the computed component rates A_{ATM}, A_{C25}, and A_{P25} are stored in the memory 10B.

$$\begin{matrix}[ Expression 13 ] & \\ ( \begin{matrix}V \\ {V}_{σ} \\ {V}_{S}\end{matrix} ) = ( \begin{matrix}{V}_{P 25} & {V}_{ATM} & {V}_{C 25} \\ {V}_{σ P 25} & {V}_{σ ATM} & {V}_{σ C 25} \\ {V}_{SP 25} & {V}_{SATM} & {V}_{SC 25}\end{matrix} ) \cdot ( \begin{matrix}{A}_{P 25} \\ {A}_{ATM} \\ {A}_{C 25}\end{matrix} ) & ( 17 )\end{matrix}$$

Note that the component rates A_{ATM}, A_{C25}, A_{P25}, which satisfy the relationships of the expression (17), can be determined by performing a computation by substituting the respective data read from the memory for a next expression (18), respectively.

$$\begin{matrix}[ Expression 14 ] & \\ ( \begin{matrix}{A}_{P 25} \\ {A}_{ATM} \\ {A}_{C 25}\end{matrix} ) = {( \begin{matrix}{V}_{P 25} & {V}_{ATM} & {V}_{C 25} \\ {V}_{σ P 25} & {V}_{σ ATM} & {V}_{σ C 25} \\ {V}_{SP 25} & {V}_{SATM} & {V}_{SC 25}\end{matrix} )}^{- 1} \cdot ( \begin{matrix}V \\ {V}_{σ} \\ {V}_{S}\end{matrix} ) & ( 18 )\end{matrix}$$

At next step 76, the spot rate S₀ and the interest rates r_{f}, r_{d} are read from the exchange information table, and the interest term T_{d}, the exercise prices K_{C25} and K_{P25} of the forward delta call plain option and the 25 forward delta put plain option, and the ATM flat volatility σ_{ATM} are read from the memory 10B. Premiums P′_{C25}, P′_{P25} of the 25 forward delta call plain option and the 25 forward delta put plain option are computed, when the ATM flat volatility σ_{ATM} is used as the volatility a by substituting the respective read information for the previous expression (15) with respect to the 25 forward delta call plain option and for the expression (16) with respect to the 25 forward delta put plain option, and the computed premiums P′_{C25} and P′_{P25} are stored in the memory 10B.

With the operations, with respect to the 25 forward delta call plain option and the forward delta put plain option, the premiums P_{C25} and P_{P25}, which are computed using the volatility σ_{C25} of the 25 forward delta call plain option and the volatility σ_{P25} of the 25 forward delta put plain option as the volatility σ, and the premiums P′_{C25} and P′_{P25}, which are computed using the ATM flat volatility σ_{ATM} as the volatility σ, are stored in the memory 10B.

At step 78, the premiums P_{C25} and P′_{C25} of the 25 forward delta call plain option and the premiums P_{P25} and P′_{P25} of the 25 forward delta put plain option are read from the memory 10B, the two types of the premiums of the 25 forward delta call plain option are substituted for a next expression (19) and a deviation (an amount of difference) Zeta_{C25} between the two types of the premiums is computed and the two types of the premiums of the forward delta put plain option are substituted for a next expression (20) and a deviation (an amount of difference) Zeta_{P25} of the premiums is computed, and the computed deviations Zeta_{C25} and Zeta_{P25} are stored in the memory 10B.

Zeta_{C25}=P_{C25}−P′_{C25} (19)

Zeta_{P25}=P_{P25}−P′_{P25} (20)

Further, at step 80, the deviations Zeta_{C25} and Zeta_{P25} computed at step 78 and the component rates A_{C25} and A_{P25} computed at previous step 74 are read from the memory 10B, a correction value Zeta is computed by substituting the respective read information for a next expression (21), and the computed correction value Zeta is stored in the memory 10B.

Zeta=A_{C25}·Zeta_{C25}+A_{P25}·Zeta_{P25} (21)

In the knock out option, since a probability that the right of option is extinguished increases as the spot rate S₀ approaches a knock out price K_{V} in which the right of option is extinguished, the premium of the option decreases as the probability that the right of option is extinguished increases. At next step 82, a Gap arrival factor R, which represents a probability of arrival of the spot rate S₀ to the knock out price K_{V}, is computed to further correct the correction value Zeta according to the probability of arrival of the spot rate S₀ to the knock out price K_{V}. Although the Gap arrival factor R is uniformly 0(%) in the plain option and the like in which the knock out price K_{V} is not set, when the currency option to be evaluated is the reverse knock out option and the like, the Gap arrival factor R can be determined by computing a premium of a digital touch option.

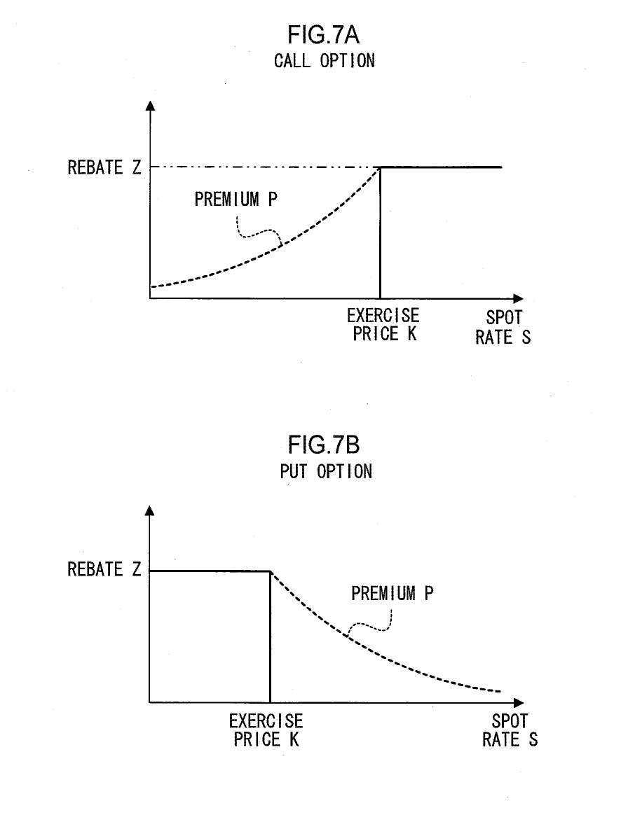

As shown in FIG. 7, the digital touch option is an option capable of receiving a predetermined rebate Z if the spot rate S becomes equal to or more than (or becomes equal to or less than) the exercise price K even once before an option exercise date. Note that, in the digital touch option, a digital touch option, which can receive the rebate Z when the spot rate S is equal to or more than the exercise price K as shown in FIG. 7(A), is called a call option, and a digital touch option, which can receive the rebate Z when the spot rate S becomes equal to or less than the exercise price, is called a put option. The premium of the digital touch option reflects the arrival factor of the spot rate S to the exercise price K, and, as shown by broken lines in FIG. 7, as the spot rate S approaches the exercise price K, the premium approaches the rebate Z, and when the spot rate S becomes equal to or more than or equal to or less than the exercise price K, the premium matches with the rebate Z. More specifically, since it can be assumed that the premium of the digital touch option per a unit rebate amount represents an arrival factor of the spot rate S to the exercise price K, the Gap arrival factor R can be determined using the premium of the digital touch option having the exercise price K equal to the knock out price K_{V} of an option to be evaluated.

In the framework of GK model, the premium of the digital touch option of the call is represented in a next expression (22), and the premium of the digital touch option of the put is represented in a next expression (23).

$$\begin{matrix}[ Expression 15 ] & \\ P = Z \cdot {e}^{- rf \cdot Td} \cdot \{ N ( {d}_{9} ) + {( \frac{{S}_{0}}{K} )}^{- ξ + 1} \cdot N ( {d}_{10} ) \} & ( 22 ) \\ P = Z \cdot {e}^{- rf \cdot Td} \cdot [ \{ 1 - N ( {d}_{9} ) + {( \frac{{S}_{0}}{K} )}^{- ξ + 1} \cdot \{ 1 - N ( {d}_{10} ) \} ] & ( 23 )\end{matrix}$$

### However,

$$\begin{matrix}[ Expression 16 ] & \\ \begin{matrix}{d}_{9} = \frac{ln ( \frac{{S}_{0}}{K} ) + ( {r}_{d} - {r}_{f} ) \cdot {T}_{d} - \frac{{σ}^{2} \cdot {T}_{e}}{2}}{σ \sqrt{{T}_{e}}} \\ {d}_{10} = \frac{ln ( \frac{{S}_{0}}{K} ) + ( {r}_{d} - {r}_{f} ) \cdot {T}_{d} - \frac{{σ}^{2} \cdot {T}_{e}}{2}}{σ \sqrt{{T}_{e}}} \\ ξ = \frac{2 \cdot ( {r}_{d} - {r}_{f} ) \cdot {T}_{d}}{{σ}^{2 } \cdot {T}_{e}}\end{matrix} \} & ( 24 )\end{matrix}$$

As described above, if the spot rate S becomes equal to or more than the exercise price K before the exercise date, since the digital touch option of the call can receive the rebate Z, the premium of the digital touch option of the call in which the rebate Z is “1” represents a probability at which the spot rate S becomes equal to or more than the exercise price K before the exercise date. Then, in the reverse knock out option of the call or in an OTM knock out option of the put, if the spot rate S becomes equal to or more than the knock out price K_{V}, the right of option is extinguished. Therefore, if the option to be evaluated is the reverse knock out option of the call or the OTM knock out option of the put, the spot rate S₀ and the interest rates r_{f}, r_{d} are read from the exchange information table, and the interest term T_{d}, the option term Tₑ, the exercise price K₀ of the currency option to be evaluated, and the ATM flat volatility σ_{ATM} are read from the memory 10B. The respective read information are substituted for the expression (22) and an expression (24), respectively, 1 is substituted for Z, a premium P of the digital touch option of the call whose interest term T_{d} and the option term Tₑ are the same as the currency option to be evaluated and in which the rebate Z is “1” is computed, and the computed premium P is stored in the memory 10B as the Gap arrival factor R.

In contrast, if the spot rate becomes equal to or less than the exercise price K before the exercise date, since the digital touch option of the put can receive the rebate Z, the premium of the digital touch option of the put in which the rebate Z is “1” represents a probability at which the spot rate S becomes equal to or less than the exercise price K before the exercise date. Then, in the reverse knock out option of the put or in the OTM knock out option of the call, if the spot rate S becomes equal to or less than the knock out price K, the right of option is extinguished. Therefore, if the option to be evaluated is the reverse knock out option of the put or the OTM knock out option of the call, the spot rate S₀ and the interest rates r_{f}, r_{d} are read from the exchange information table, and the interest term T_{d}, the option term Tₑ, the exercise price K₀ of the currency option to be evaluated, and the ATM flat volatility σ_{ATM} are read from the memory 10B. The respective read information are substituted for the expressions (23), (24), respectively, 1 is substituted for Z, a premium P of the digital touch option of the put whose interest term T_{d} and the option term Tₑ are the same as the currency option to be evaluated and in which the rebate Z is “1” is computed, and the computed premium P is stored in the memory 10B as the Gap arrival factor R.

At next step 84, the correction value Zeta computed at previous step 80 and the GAP arrival factor R computed at step 82 are read from the memory 10B, and the respective read information are substituted for a next expression (25), respectively, thereby performing a correction computation of the correction value Zeta, and the correction value Zeta after correction is stored in the memory 10B.

Zeta=(1−R)·Zeta (25)

In the expression (25), (1−R) represents a probability at which the currency option to be evaluated exists until the exercise date (the right is not extinguished). Since GAP arrival factor R=0(%) in a plain option and the like in which the knock out price K_{V} is not set, (1−R)=1 is established and a value of the correction value Zeta does not change regardless of the correction computation. However, in a barrier option such as the knock out option, a knock in option, and the like in which the knock out price K_{V} is set, since Gap arrival factor R>0(%), (1−R)<1 is established and thus as the smaller a probability at which the currency option to be evaluated exists until the exercise date is, the smaller the value of the correction value Zeta after it is corrected becomes.

At next step 86, the premium P₀ of the currency option to be evaluated is corrected by the correction value Zeta by reading the premium P₀ of the currency option to be evaluated, which is computed at previous step 80, and the correction value Zeta, which is subjected to the correction computation at step 84, from the memory 10B, and computing a next expression (26) by substituting the respective read information for the expression (26), and the premium P₀ after correction is stored in the memory 10B.

P₀=P₀+Zeta (26)

At step 88, the premium P₀, which is subjected to the correction computation at step 84, is read from the memory 10B, and the read premium P₀ is output as the premium of the currency option to be evaluated (for example, displayed on the display 12), thereby finishing the premium computation processing.

As described above, in the embodiment, with respect to the 25 forward delta call plain option, the premium P_{C25} when the volatility σ_{C25} of the 25 forward delta call plain option is used and the premium P′_{C25} when the ATM flat volatility σ_{ATM} is used are computed, and the deviation Zeta_{C25} between the premium P_{C25} and the premium P′_{C25} is computed. Further, with respect to also the 25 forward delta put plain option, the premium P_{P25} when the volatility σ_{P25} of the 25 forward delta put plain option is used and the premium P′_{P25} when the ATM flat volatility σ_{ATM} is used are computed, and a deviation Zeta_{P25} between the premium P_{P25} and the premium P′_{P25} is computed. The correction value Zeta is computed by adding the respective deviations after the deviations are weighted according to the component rate of the respective plain options of a portfolio, which is obtained by combining the ATM plain option, the 25 forward delta call plain option, and the 25 forward delta put plain option when the vega V, the volga V_{σ}, the vanna Vₛ of the portfolio is equal to the vega V, the volga V_{σ}, the vanna Vₛ of the currency option to be evaluated. Since the premium P₀ of the currency option to be evaluated, which is computed using the ATM flat volatility σ_{ATM}, is corrected by the correction value Zeta, an error of the probability distribution, which is used as a premise by the model (the framework of GK model) used to compute the premium of the currency option, can be corrected. As a result, an appropriate value, which accurately reflects the magnitude of risk of a risk guarantor of the currency option, can be obtained as the premium of the currency option to be evaluated.

Further, in the embodiment, as an option other than the ATM plain option used to a computation of the correction value Zeta and the like, the 25 forward delta call plain option and the 25 forward delta put plain option whose exercise terms are the same as the currency option to be evaluated and in which a delta is 0.25 based on the forward rate are applied, and the volatility Δσ_{RR} of the 25 delta risk reversal and the volatility Δσ_{BF} of the 25 delta butterfly, which represent the market values of the 25 forward delta call plain option and the 25 forward delta put plain option, are obtained. The exercise price K_{C25} of the 25 forward delta call plain option is computed using the volatility σ_{C25} of the 25 forward delta call plain option and the exercise price K_{P25} of the 25 forward delta put plain option is computed using the volatility σ_{P25} of the 25 forward delta put plain option. Accordingly, since the exercise price K_{ATM} of the ATM plain option is prevented from becoming equal to the exercise prices K_{C25}, K_{P25} of the 25 forward delta call plain option and the 25 forward delta put plain option, a circumstance in which the premium of the currency option to be evaluated is placed in an incomputable state can be avoided.

Note that an aspect is explained above in which the 25 forward delta plain option and the ATM plain option having a high fluidity are applied as the plain options used to the computation of the correction value to the premium of the currency option to be evaluated. However, the invention is by no means limited to the aspect, and a forward delta call plain option in which a delta has other value based on the forward rate, for example, a 10 forward delta plain option and the like may be used as long as a fluidity is secured.

Further, an aspect is explained in which the vega, the volga, the vanna are used as the predetermined risk parameters (in more detail, parameters representing a risk to a change of volatility) is explained above. However, the invention is by no means limited to the aspect, however, one or two parameters may be selected and used from the vega, the volga, and the vanna, a different risk parameter (for example, a parameter which represents a risk to a change of index other than the volatility) may be used, or the different risk parameter may be added to the vega, the volga, and the vanna (or to one or two parameters selected from the vega, the volga, and the vanna) for use.

Further, although an aspect is explained above in which the premium computation program of the currency option according to the invention is previously stored in (installed to) the storage unit 10C of the computer 10, the premium computation program of the currency option according to the invention may be provided by being stored on a storage medium such as a CD-ROM and a DVD-ROM. The aspect corresponds to the invention according to the tenth claim.

### REFERENCE NUMERALS

10 the computer
10B memory
10C storage unit
12 display
14 keyboard
20 exchange information providing system

1. A premium computation device for a currency option comprising:
a first acquisition unit which obtains a first parameter capable of specifying an exercise date and an exercise term of a currency option to be evaluated and a second parameter representing an exercise price or a delta of the currency option to be evaluated and which stores the obtained first parameter and second parameter in a first storage unit;
a second acquisition unit which obtains an ATM flat volatility representing a market value of a volatility of an ATM plain option whose exercise term is the same as the exercise term of the currency option to be evaluated which is capable of being specified from the first parameter and volatility information representing a market value of a volatility of a forward delta call plain option and a volatility of a forward delta put plain option in which a delta has a predetermined value based on a forward rate that is an exchange rate uniquely determined from a spot rate, an interest rate and a term at an exercise date of the currency option to be evaluated whose exercise term is the same as the currency option to be evaluated and which is capable of being specified from the first parameter and which stores the obtained ATM flat volatility and volatility information in a second storage unit;
a first premium computation unit which reads the second parameter from the first storage unit and reads the ATM flat volatility from the second storage unit, which computes a premium of the currency option to be evaluated using the ATM flat volatility read from the second storage unit and an exercise price of the currency option to be evaluated by computation processing of a computer, after the exercise price of the currency option to be evaluated is computed based on a delta of the currency option to be evaluated represented by the second parameter by computation processing of the computer if the second parameter read from the first storage unit represents a delta of the currency option to be evaluated, and which stores the computed premium of the currency option to be evaluated in a third storage unit;
a risk parameter computation unit which reads the ATM flat volatility from the second storage unit and reads the premium of the currency option to be evaluated from the third storage unit, which computes a predetermined risk parameter with respect to the currency option to be evaluated using the ATM flat volatility read from the second storage unit and the premium of the currency option to be evaluated read from the third storage unit by computation processing of the computer, and which stores the computed predetermined risk parameter in a fourth storage unit;
an exercise price computation unit which reads the ATM flat volatility and the volatility information from the second storage unit, which computes an exercise price of the ATM plain option using the ATM flat volatility read from the second storage unit and computes an exercise price of the forward delta call plain option using a volatility of the forward delta call plain option represented by the volatility information read from the second storage unit by computation processing of the computer, which further computes an exercise price of the forward delta put plain option using a volatility of the forward delta put plain option represented by the volatility information read from the second storage unit by computation processing of the computer, and which stores the computed exercise prices of the respective plain options in a fifth storage unit;
a second premium computation unit which reads the ATM flat volatility and the volatility information from the second storage unit and reads the exercise prices of the respective plain options from the fifth storage unit, which computes a premium of the ATM plain option using the ATM flat volatility read from the second storage unit and the exercise price of the ATM plain option read from the fifth storage unit and computes a premium of the forward delta call plain option using the volatility of the forward delta call plain option represented by the volatility information read from the second storage unit and the exercise price of the forward delta call plain option read from the fifth storage unit by computation processing of the computer, which further computes a premium of the forward delta put plain option using the volatility of the forward delta put plain option represented by the volatility information read from the second storage unit and the exercise price of the forward delta put plain option read from the fifth storage unit by computation processing of the computer, and which stores the computed premiums of the respective plain options in a sixth storage unit;
a component rate computation unit which reads the predetermined risk parameter of the currency option to be evaluated from the fourth storage unit, reads the ATM flat volatility and the volatility information from the second storage unit and reads the premiums of the respective plain options from the sixth storage unit, which computes a component rate of the respective plain options in a portfolio when a value of the predetermined risk parameter with respect to the portfolio obtained by combining the respective plain options determined from the ATM flat volatility and the volatility information read from the second storage unit and the premiums of the respective plain options read from the sixth storage unit is equal to the value of the predetermined risk parameter of the currency option to be evaluated read from the fourth storage unit by computation processing of the computer, and which stores the computed component rate in a seventh storage unit;
a third premium computation unit which reads the ATM flat volatility from the second storage unit and reads the exercise prices of the respective plain options from the fifth storage unit, which computes a premium of the forward delta call plain option using the ATM flat volatility read from the second storage unit and the exercise price of the forward delta call plain option read from the fifth storage unit and computes a premium of the forward delta put plain option using the ATM flat volatility read from the second storage unit and the exercise price of the forward delta put plain option read from the fifth storage unit by computation processing of the computer, and which stores the computed premiums of the respective plain options in an eighth storage unit;
a deviation computation unit which reads the premiums of the respective plain options from the sixth storage unit and the eighth storage unit, which computes deviations between the premiums read from the sixth storage unit and the premiums read from the eighth storage unit for each of the respective plain options by computation processing of the computer, and which stores the computed deviations in a ninth storage unit;
a correction value computation unit which reads the deviations of the respective plain options from the ninth storage unit and reads the component rate from the seventh storage unit, which computes a value obtained by adding the deviations of the respective plain options read from the ninth storage unit after the deviations are weighted according to the component rate read from the seventh storage unit as a correction value to the premium of the currency option to be evaluated by computation processing of the computer, and which stores the computed correction value in a tenth storage unit;
a correction unit which reads the premium of the currency option to be evaluated from the third storage unit and reads the correction value from the tenth storage unit, which corrects the premium of the currency option to be evaluated read from the third storage unit by the correction value read from the tenth storage unit by computation processing of the computer, and which stores the premium after the correction in an eleventh storage unit; and
an output unit which reads the premium after the correction from the eleventh storage unit and which outputs the read premium after the correction as the premium of the currency option to be evaluated.

2. The premium computation device for a currency option according to claim 1, wherein the exercise price computation unit computes an exercise price in a reference currency in a payment of the premium of the currency option of a first currency and a second currency to be exchanged in the currency option to be evaluated, and the first to third premium computation units compute the premiums in the reference currency.

3. The premium computation device for a currency option according to claim 1, wherein when a cumulative probability density function of a standard normal distribution is N( ), a delta value based on the forward rate is Δ, a volatility of a forward delta plain option is σ, an exercise term of the forward delta plain option is T_{c}, the exercise price computation unit searches and determines a value of a variable D₂ that satisfies the following expression (1) by computation processing of the computer,
[Expression 1]
N(−D₂)−|Δ|·e^{(D}^{₂}^{·σ·√Te+σ}^{²}^{·Te/2)}=0 (1)
when a spot rate is S₀, an interest rate of a reference currency in a payment of the premium of the currency option of a first currency and a second currency to be exchanged in the currency option to be evaluated is r_{f}, an interest rate of a non-reference currency of the first currency and the second currency is r_{d}, and an interest term is T_{d}, the value of the variable D₂ that satisfies the determined expression (1) is substituted into the following expression (2) by computation processing of the computer,
[Expression 2]
K=S₀e^{(rd-rf)·Td}·e^{(-D}^{₂}^{·σ·√Te-σ}^{²}^{·Te/2)} (2)
and then processing for computing an exercise price K is performed with respect to the forward delta call plain option and the forward delta put plain option, thereby computing the exercise prices of the forward delta call plain option and the forward delta put plain option.

4. The premium computation device for a currency option according to claim 1, further comprising a third acquisition unit which obtains spot rates of a first currency and a second currency to be exchanged in the currency option to be evaluated and interest rates of the first currency and the second currency, from another computer connected via a communication line, and which stores the obtained spot rates and the obtained interest rates of the first currency and the second currency in a twelfth storage unit,
wherein the first to the third premium computation units, the risk parameter computation unit, the exercise price computation unit, and the component rate computation unit read the spot rates and the interest rates from the twelfth storage unit and perform the computations also using the spot rates and the interest rates read from the twelfth storage unit.

5. The premium computation device for a currency option according to claim 1, wherein after the component rate computation unit computes predetermined risk parameters of the ATM plain option, the forward delta call plain option, and the forward delta put plain option, by computation processing of the computer using the ATM flat volatility and the volatility information read from the second storage unit and the premiums of the respective plain options read from the sixth storage unit, the component rate computation unit computes the component rate of the respective plain options in the portfolio using the computed predetermined risk parameters of the respective plain options.

6. The premium computation device for a currency option according to claim 1, wherein the predetermined risk parameters are parameters representing a risk with respect to a change of volatility.

7. The premium computation device for a currency option according to claim 6, wherein the predetermined risk parameters include at least one of a vega obtained by first-order differentiating the premium of the currency option by a volatility, a volga obtained by second-order differentiating the premium by a volatility, and a vanna obtained by first-order differentiating the vega by a spot rate.

8. The premium computation device for a currency option according to claim 1, wherein the forward delta call plain option is a 25 forward delta call plain option in which a delta based on the forward rate is 0.25, and the forward delta put plain option is a 25 forward delta put plain option in which a delta based on the forward rate is 0.25.

9. (canceled)

10. A storage medium in which a premium computation program for a currency option is stored, wherein the premium computation program causes a computer including a first storage unit to an eleventh storage unit to function as:
a first acquisition unit which obtains a first parameter capable of specifying an exercise date and an exercise term of a currency option to be evaluated and a second parameter representing an exercise price or a delta of the currency option to be evaluated and which stores the obtained first parameter and second parameter in the first storage unit;
a second acquisition unit which obtains an ATM flat volatility representing a market value of a volatility of an ATM plain option whose exercise term is the same as the exercise term of the currency option to be evaluated which is capable of being specified from the first parameter and volatility information representing a market value of a volatility of a forward delta call plain option and a volatility of a forward delta put plain option in which a delta has a predetermined value based on a forward rate that is an exchange rate uniquely determined from a spot rate, an interest rate and a term at an exercise date of the currency option to be evaluated whose exercise term is the same as the currency option to be evaluated and which is capable of being specified from the first parameter and which stores the obtained ATM flat volatility and volatility information in the second storage unit;
a first premium computation unit which reads the second parameter from the first storage unit and reads the ATM flat volatility from the second storage unit, which computes a premium of the currency option to be evaluated using the ATM flat volatility read from the second storage unit and an exercise price of the currency option to be evaluated by computation processing of a computer, after the exercise price of the currency option to be evaluated is computed based on a delta of the currency option to be evaluated represented by the second parameter by computation processing of the computer if the second parameter read from the first storage unit represents a delta of the currency option to be evaluated, and which stores the computed premium of the currency option to be evaluated in the third storage unit;
a risk parameter computation unit which reads the ATM flat volatility from the second storage unit and reads the premium of the currency option to be evaluated from the third storage unit, which computes a predetermined risk parameter with respect to the currency option to be evaluated using the ATM flat volatility read from the second storage unit and the premium of the currency option to be evaluated read from the third storage unit by computation processing of the computer, and which stores the computed predetermined risk parameter in the fourth storage unit;
an exercise price computation unit which reads the ATM flat volatility and the volatility information from the second storage unit, which computes an exercise price of the ATM plain option using the ATM flat volatility read from the second storage unit and computes an exercise price of the forward delta call plain option using a volatility of the forward delta call plain option represented by the volatility information read from the second storage unit by computation processing of the computer, which further computes an exercise price of the forward delta put plain option using a volatility of the forward delta put plain option represented by the volatility information read from the second storage unit by computation processing of the computer, and which stores the computed exercise prices of the respective plain options in the fifth storage unit;
a second premium computation unit which reads the ATM flat volatility and the volatility information from the second storage unit and reads the exercise prices of the respective plain options from the fifth storage unit, which computes a premium of the ATM plain option using the ATM flat volatility read from the second storage unit and the exercise price of the ATM plain option read from the fifth storage unit and computes a premium of the forward delta call plain option using the volatility of the forward delta call plain option represented by the volatility information read from the second storage unit and the exercise price of the forward delta call plain option read from the fifth storage unit by computation processing of the computer, which further computes a premium of the forward delta put plain option using the volatility of the forward delta put plain option represented by the volatility information read from the second storage unit and the exercise price of the forward delta put plain option read from the fifth storage unit by computation processing of the computer, and which stores the computed premiums of the respective plain options in the sixth storage unit;
a component rate computation unit which reads the predetermined risk parameter of the currency option to be evaluated from the fourth storage unit, reads the ATM flat volatility and the volatility information from the second storage unit, reads the premiums of the respective plain options from the sixth storage unit, which computes a component rate of the respective plain options in a portfolio when a value of the predetermined risk parameter with respect to the portfolio obtained by combining the respective plain options determined from the ATM flat volatility and the volatility information read from the second storage unit and the premiums of the respective plain options read from the sixth storage unit is equal to the value of the predetermined risk parameter of the currency option to be evaluated read from the fourth storage unit by computation processing of the computer, and which stores the computed component rate in the seventh storage unit;
a third premium computation unit which reads the ATM flat volatility from the second storage unit and reads the exercise prices of the respective plain options from the fifth storage unit, which computes a premium of the forward delta call plain option using the ATM flat volatility read from the second storage unit and the exercise price of the forward delta call plain option read from the fifth storage unit and computes a premium of the forward delta put plain option using the ATM flat volatility read from the second storage unit and the exercise price of the forward delta put plain option read from the fifth storage unit by computation processing of the computer, and which stores the computed premiums of the respective plain options in the eighth storage unit;
a deviation computation unit which reads the premiums of the respective plain options from the sixth storage unit and the eighth storage unit, which computes deviations between the premiums read from the sixth storage unit and the premiums read from the eighth storage unit for each of the respective plain options by computation processing of the computer, and which stores the computed deviations in the ninth storage unit;
a correction value computation unit which reads the deviations of the respective plain options from the ninth storage unit and reads the component rate from the seventh storage unit, which computes a value obtained by adding the deviations of the respective plain options read from the ninth storage unit after the deviations are weighted according to the component rate read from the seventh storage unit as a correction value to the premium of the currency option to be evaluated by computation processing of the computer, and which stores the computed correction value in the tenth storage unit;
a correction unit which reads the premium of the currency option to be evaluated from the third storage unit and reads the correction value from the tenth storage unit, which corrects the premium of the currency option to be evaluated read from the third storage unit by the correction value read from the tenth storage unit by computation processing of the computer, and which stores the premium after the correction in the eleventh storage unit; and
an output unit which reads the premium after the correction from the eleventh storage unit and which outputs the premium after the correction as the premium of the currency option to be evaluated.
